(19) United States
(12) Patent Application Publication
(10) Pub. No.: US 2011/0173029 A1
(43) Pub. Date: Jul. 14, 2011

(54) RECURRING TIME ZERO

(75) Inventors: YEGOR FARIDOVICH HANOV, Overland Park, KS (US); KIM INCE, Raymore, MO (US); FRAN PIVONKA, Lenexa, KS (US); LEI HAN, Overland Park, KS (US); DENNIS HUBER, Kansas City, MO (US)

(73) Assignee: CERNER INNOVATION, INC., Overland Park, KS (US)

(21) Appl. No.: 12/987,864

(22) Filed: Jan. 10, 2011

Related U.S. Application Data
(60) Provisional application No. 61/293,523, filed on Jan. 8, 2010.

(51) Int. Cl. G06Q 50/00

(52) U.S. Cl. 705/3

(57) ABSTRACT

Computerized methods and systems in a clinical computing environment are provided for methods and systems in a clinical computing environment for collectively ordering recurring orders. Each treatment period (that is, each instance of a recurring order or group of orders) is permitted to be activated independently even though the ordering activity for the treatment schedule takes place only once. Relationships between orders within a recurring group or phase, as well as relationships between different instances of the group or phase (e.g., between treatment periods included in a treatment schedule wherein the same group of orders is to be executed on two different days) are established utilizing time offsets. Each time that a treatment period is activated, a new time zero is established and future administration times are calculated utilizing the time offsets with respect to the new time zero. Additionally, each time that a treatment period is activated and a new time zero is established, future treatment periods included in the treatment schedule are scheduled for future initiation based upon the time offsets.

### BACKGROUND

Clinical protocols often require that a number of different things be done in a certain sequence and the timing of the sequence is very important. Time-zero represents the time that the chemotherapy agent is administered. For instance, a chemotherapy protocol may require hydration two hours before chemotherapy administration and a lab two hours after administration is complete. In this instance, chemo medication order is considered the time zero. Each of the other items in the sequence is then set to take place at a particular time offset with respect to the time-zero item or order. In the above example, hydration order would be offset from time-zero by negative two hours (or a clinically acceptable time range including the time that is two hours prior to chemotherapy administration) and the lab draw would be offset from the chemotherapy administration by two hours (or a clinically acceptable time range including the time that is two hours from the chemotherapy administration). Actions taking place outside of the time frame, may lead to inaccurate results and, ultimately, affect patient safety.

Clinical orders are requests placed by healthcare providers or clinicians and are generally for, e.g., procedures, medications, laboratory tests, evaluations, treatments, nursing tasks to be done for a patient, and the like. A healthcare plan includes multiple orders for treatment for a particular problem or ailment. For example, a healthcare plan for a cancer patient may include multiple medication orders, laboratory testing orders and orders for diagnostic tests. Often times, an order (or set of orders) will set forth a healthcare plan having components which span multiple patient visits. For instance, a healthcare plan for a chemotherapy protocol may specify that a particular medication is to be given in a specified dosage on three separate days, e.g., Day 1, Day 8, and Day 15. In this instance, each day may be viewed as a separate phase of a plan. Phases, however, are not limited to units of time. In simple terms, a phase is merely a plan within a plan and, accordingly, may be a unit of time, a diagnostic grouping, or any other sub-plan within a healthcare plan.

Many protocols have a series of orders with a recurring pattern. For instance, the same chemotherapy regimen may take place multiple times—once per week, once per day, or the like. To accommodate this situation, orders for each treatment period (that is, orders for each instance of the recurring regimen) are generally ordered as a separate phase. This is not ideal, however, as it leads to much duplicate activity. For instance, clinicians must build each phase (even though each phase is identical), initiate each phase, verify the orders in the phase each time a phase is initiated, and the like. Further, each instance of a particular order is presented one time for each phase for which it is ordered—which can lead to confusion with respect to determining what has been done and what remains to be done. Still further, there is generally no relationship between the phases, that is, no way for the clinical computing system to determine if two phases are being implemented too close together, too far apart, etc.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to methods and systems in a clinical computing environment for collectively ordering recurring orders, e.g., chemotherapy protocols where the same group of medications is to be administered in the same order multiple times over the course of several days. Embodiments hereof permit each treatment period (that is, each instance of a recurring order or group of orders) to be activated independently (e.g., on different encounters) even though the ordering activity for the treatment schedule (that is, all treatment periods or instances of the recurring order or group of orders) takes place only once. Relationships between orders within a recurring group or phase, as well as relationships between different instances of the group or phase (e.g., between treatment periods included in a treatment schedule wherein the same group of orders is to be executed on two different days) are established utilizing time offsets. Each time that a treatment period (i.e., an instance of the recurring order or group of orders) is activated, a new time zero is established and future administration times are calculated utilizing the time offsets with respect to the new time zero. Additionally, each time that a treatment period (i.e., an instance of the recurring order or group of orders) is activated and a new time zero is established, future treatment periods included in the treatment schedule are scheduled for future initiation based upon the time offsets.

Accordingly, in one embodiment, the present invention relates to one or more computer-readable storage media having computer-executable instructions embodied thereon that, when executed, perform a method for collectively ordering instances of recurring orders. The method includes receiving an order, the received order having an order detail associated therewith indicating that it is to be repeated a plurality of times on a specified schedule, and permitting each instance of the order to be independently activated the plurality of times.

In another embodiment, the present invention relates to a method for collectively ordering multiple treatment periods associated with a single treatment schedule order. The method includes receiving an order indication for a treatment schedule, the treatment schedule having a plurality of treatment periods; receiving an indication to activate a first of the plurality of treatment periods; activating the first of the plurality of treatment periods; receiving an indication to activate a second of the plurality of treatment periods; and activating the second of the plurality of treatment periods. A second order indication is not received prior to activating the second of the plurality of identical treatment periods.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a screen display is illustrated of an exemplary user interface showing a sample treatment schedule having a repeatable group of chemotherapy orders assigned to a plurality individual treatment periods, in accordance with an embodiment of the present invention;

FIG. 3 is a screen display of an exemplary user interface illustrating the relationship between the series of orders delineated in FIG. 2 (represented by characters A, B, C, D, and E), in accordance with an embodiment of the present invention;

FIG. 4 is a screen display of an exemplary user interface for use in building a treatment schedule having a plurality of repeatable orders, in accordance with an embodiment of the present invention;

FIG. 5 is a screen display of an exemplary add-plan dialog box for a chemotherapy plan with at least one phase having a plurality of recurring orders, in accordance with an embodiment of the present invention;

FIG. 6 is a screen display of an exemplary add-plan dialog box for the chemotherapy plan of FIG. 5 once the expand/collapse icon is selected, in accordance with an embodiment of the present invention;

FIG. 7 is a screen display, in accordance with an embodiment of the present invention, illustrating an exemplary user interface showing a calendar-view of a planned phase of treatment, the phase orders placed in accordance with an embodiments of the present invention;

FIG. 8 is a screen display of an exemplary user interface showing that if an order or outcome is assigned to a treatment period, the text “Planned” may be presented in the column representing the treatment period to which it is assigned, in accordance with an embodiment of the present invention;

FIG. 9 is a screen display showing an exemplary dialog that may be displayed once a user has selected to add to the phase or treatment period, the illustrated dialog prompting the user to select which treatment period the order, outcome, or prescription is to be added, in accordance with an embodiment of the present invention;

FIG. 10 is a screen display of an exemplary user interface showing that within the treatment schedule view, order sentences may be presented below the order mnemonic with a visual indication being presented before the order sentence if there is more than one order sentence predefined, in accordance with an embodiment of the present invention;

FIGS. 11 and 12, respectively, are screen displays of exemplary user interfaces showing that, in accordance with embodiments of the present invention, phases having one or more sub-phases may have names that are presented with the text “Show Details” (FIG. 11) or “Hide Details” (FIG. 12) below the name;

FIG. 13 is a screen display of an exemplary user interface showing that, upon selection of a vertical column representing a particular day of treatment in the calendar view of a healthcare phase ordered in accordance with embodiments of the present invention, the orders in the vertical column may be activated, in accordance with an embodiment of the present invention;

FIG. 14 is a screen display of an exemplary user interface showing that once the chemotherapy phase is “Initiated” or “Future Initiated,” the treatment schedule view displays the status of the individual orders for each treatment period, in accordance with an embodiment of the present invention;

FIG. 15 is a screen display of an exemplary user interface showing that once a treatment period is activated, the orders being activated are presented in orders for signature, in accordance with an embodiment of the present invention;

FIG. 16 is a screen display of an exemplary user interface showing that after the orders are signed and the user refreshes the profile, the activated treatment period status is updated from “Future” to “Initiated” and the orders are in a status of “Ordered,” in accordance with an embodiment of the present invention;

FIG. 17 is a screen display of an exemplary dialog, in accordance with embodiments of the present invention, that may be displayed if the start date/time of the treatment period being activated is more than one day in the past;

FIG. 18 is a screen display of an exemplary user interface showing that if a treatment period is activated out of sequence, a warning message may be presented to notify the user that the treatment periods that have not been activated will be canceled, in accordance with an embodiment of the present invention;

FIG. 19 is a screen display of an exemplary user interface showing that in accordance with embodiments of the present invention, the day-of-treatment orders present only the treatment period assigned to the order on the clinical display line;

FIG. 20 is a screen display of an exemplary user interface showing that electronic medication management applications may by default present the protocol order with the assigned treatment periods in the order sentence and that upon selecting the “+” sign, the protocol order to display the day-of-treatment orders that are related may be shown, in accordance with an embodiment of the present invention;

FIG. 21 is a screen display of an exemplary user interface showing that in accordance with embodiments of the present invention, protocol orders may be presented in a “Medications” column of an electronic medical record;

FIG. 22 is a screen display of an exemplary user interface showing that in accordance with embodiments of the present invention, to view the variance information related to a result, users may hover over the corresponding treatment period to present a tool tip containing variance information;

FIG. 23 is a screen display of an exemplary user interface showing that in accordance with embodiments of the present invention, an outcome results window may present a list of results based on the result range on the initial load;

FIG. 24 is a screen display of an exemplary user interface showing that within the electronic medical document, outcomes assigned to treatment periods may be grouped by the name of the treatment period and sorted in ascending order, in accordance with embodiments of the present invention;

FIG. 25 is a screen display of an exemplary user interface showing that to discontinue orders for a specific treatment period, in accordance with embodiments of the present invention, a user may select the “Discontinue” option from the “Actions” menu in the selected treatment period column;

FIG. 26 is a screen display of an exemplary “Change Time Zero” dialog box, in accordance with embodiments of the present invention;

FIG. 27 is a screen display of an exemplary user interface showing a “Change Start Date/Time” dialog, in accordance with embodiments of the present invention;

FIG. 28 is a screen display of an exemplary user interface showing that orders in a plan may be rescheduled in the electronic medical record, in accordance with embodiments of the present invention; and

FIG. 29 is a screen display of an exemplary user interface showing that a user may make any changes to the date and time of the order, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to methods and systems in a clinical computing environment for collectively ordering recurring orders, e.g., chemotherapy protocols where the same group of medications is to be administered in the same order multiple times over the course of several days. Embodiments hereof permit each treatment period (that is, each instance of a recurring order or group of orders) to be activated independently (e.g., on different encounters) even though the ordering activity for the treatment schedule (that is, all treatment periods or instances of the recurring order or group of orders) takes place only once. This supports clinical billing requirements while having the user see only one order, verify one order, and document against one order.

Relationships between orders within a recurring group or phase, as well as relationships between different instances of the group or phase (e.g., between treatment periods included in a treatment schedule wherein the same group of orders is to be executed on two different days) are established utilizing time offsets. Each time that a treatment period (i.e., an instance of the recurring order or group of orders) is activated, a new time zero is established and future administration times are calculated utilizing the time offsets with respect to the new time zero. Additionally, each time that a treatment period (i.e., an instance of the recurring order or group of orders) is activated and a new time zero is established, future treatment periods included in the treatment schedule are scheduled for future initiation based upon the time offsets. Embodiments hereof further permit time-zero orders to be rescheduled as a group. Adjustments to a partial day of treatment, a whole day of treatment, or all days of treatment within a treatment schedule may be made. An exemplary operating environment for embodiments of the present invention is described below.

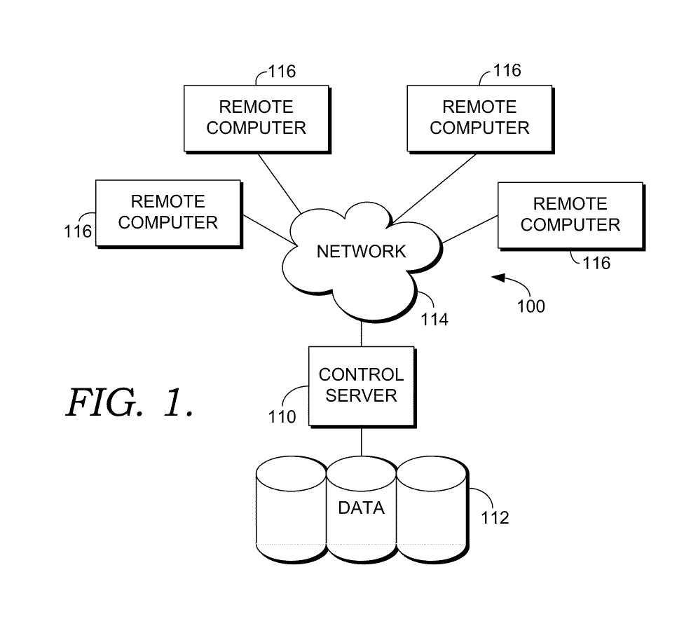

Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of embodiments of the invention. Neither should the medical information computing system environment 100 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, mobile computing systems, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 110. Components of the server 110 may include, without limitation, a processing unit, internal system memory, and a suitable system bus for coupling various system components, including the database cluster 112, with the server 110. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 110 typically includes, or has access to, a variety of computer-readable media, for instance, the database cluster 112. Computer-readable media can be any available media that may be accessed by the server 110, and includes volatile and nonvolatile media, as well as removable and non-removable media. By way of example, and not limitation, computer readable media may comprise computer-readable storage media. Computer-readable storage media may include, without limitation, volatile and nonvolatile media, as well as removable and non-removable media implemented in any method or technology for storage of information, such as computer-readable instructions, data structures, program modules, or other data. In this regard, computer-readable storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 110. Combinations of any of the above also may be included within the scope of computer-readable media.

The computer-readable storage media discussed above and illustrated in FIG. 1, including database cluster 112, provide storage of computer-readable instructions, data structures, program modules, and other data for the server 110.

The server 110 may operate in a computer network 114 using logical connections to one or more remote computers 116. The remote computers 116 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians; specialists such as surgeons, radiologists, cardiologists, and oncologists; mid-level providers; residents; fellows; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 116 may also be physically located in non-traditional medical care environments so that the entire health care community may be capable of integration on the network. The remote computers 116 may be personal computers, mobile computing devices, wireless computing devices, servers, routers, network PCs, peer devices, other common network nodes, or the like, and may include some or all of the elements described above in relation to the server 110. The devices can be personal digital assistants or other like devices.

Exemplary computer networks 114 may include, without limitation, local area networks (LANs) and/or wide area networks (WANs). Such networking environments are commonplace in offices, enterprise-wide computer networks, intranets, and the Internet. When utilized in a WAN networking environment, the server 110 may include a modem or other means for establishing communications over the WAN, such as the Internet. In a networked environment, program modules or portions thereof may be stored in the server 110, in the database cluster 112, or on any of the remote computers 116. For example, and not by way of limitation, various application programs may reside on the memory associated with any one or more of the remote computers 116. It will be appreciated by those of ordinary skill in the art that the network connections shown are exemplary and other means of establishing a communications link between the computers (e.g., the server 110 and one or more of the remote computers 116) may be utilized.

In operation, a user may enter commands and information into the server 110 or convey the commands and information to the server 110 via one or more of the remote computers 116 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 110. In addition to a monitor, the server 110 and/or remote computers 116 may include other peripheral output devices, such as speakers and a printer.

Although many other internal components of the server 110 and the remote computers 116 are not shown, those of ordinary skill in the art will appreciate that such components and their interconnection are well known. Accordingly, additional details concerning the internal construction of the server 110 and the remote computers 116 are not further disclosed herein.

Although methods and systems of embodiments of the present invention are described as being implemented in a WINDOWS operating system, operating in conjunction with an Internet-based system, one of ordinary skill in the art will recognize that the described methods can be implemented in any system supporting collectively building and ordering groups of repeatable orders. As contemplated by the language above, the methods of embodiments of the present invention may also be implemented on a stand-alone desktop, personal computer, or any other computing device used in a healthcare environment, home-computing environment, or any of a number of other locations.

As previously mentioned, embodiments of the present invention relate to methods and systems in a clinical computing environment for collectively ordering recurring orders, e.g., chemotherapy protocols where the same group of medications is to be administered in the same order multiple times over the course of several days. As utilized herein, a “protocol” describes an explicit, detailed plan of treatment for a specific medical treatment. A “protocol order” is an order that originated from an electronic treatment plan (e.g., from a PowerPlan, available from Cerner Corporation of Kansas City, Mo.) and is defined to span multiple days of treatment and to occur on specific days within a treatment schedule. By way of example, a protocol order may specify administration of “Ifsofamide 1300 mg/m², IV, once, Days 1-5.” This exemplary protocol order spans the entire treatment of days one through five.

A protocol order is associated with at least one, and generally multiple, day-of-treatment orders. A “day-of-treatment order” is an order that is a child of a protocol order and only occurs on its assigned day of treatment. Using the above example, there would be five day-of-treatment orders in the system, each day-of-treatment order with a relationship to the protocol order. Day-of-treatment orders may be either day-of-treatment one-time orders or day-of-treatment template orders. A “day-of-treatment one-time order” is a day-of-treatment order that has a frequency with a meaning of one-time. An exemplary day-of-treatment one-time order would be administration of “Ifosfamide, 1300 mg/m², IV, once, Day 1.” A “day-of-treatment template order” is a group order that represents that clinical activity is to occur more than once a day. A template order will always be associated with a protocol order and will always have a frequency that will create one or more child orders. An exemplary “day-of-treatment template order” would be administration of “Mesna, 360 mg/m², IV, every 4 hours×2 doses, Day 1.”

A “treatment period interval” represents the time interval between treatment periods (days of treatment), generally defined in days. Treatment period intervals are used with a healthcare plan to calculate days of treatment. By way of example, a treatment schedule with treatment to be given on Day 1, Day 8 and Day 15 has a treatment period interval equal to seven days between treatment periods. A treatment schedule with treatment delivered on Day 1, Day 2, Day 3, Day 4 and Day 5 has a treatment period interval equal to one day between each treatment period.

A “treatment period duration” represents the time frame in which the day-of-treatment orders (one-time or template) within a phase are to be completed. This applies both to medication orders and non-medication orders. By way of example, a treatment schedule defined for Day 1, Day 8 and Day 15 with seven day treatment period intervals may have an expectation that the treatment given on Day 1 should not last longer than twenty-four hours.

A “minimum tolerance interval,” as utilized herein, is the recommended minimum amount of time between two instances within a day-of-treatment order and across multiple day-of-treatment orders. As more fully described below, in embodiments, with this relationship established between day-of-treatment orders, the user may receive an alert or warning if a greater amount of time exists. For instance, if a chemotherapy drug is assigned to be given once on Day 1, Day 2, Day 3, Day 4 and Day 5 and the minimal tolerance interval is defined as eight hours, if a user tries to move the start date/time on the order for Day 2 closer to the order on Day 1 and there are not eight hours between the two orders, the user may receive a warning message that the doses are too close. In embodiments, the user will be permitted to continue through the warning message. Units may include minutes, hours, days, weeks, and the like. In embodiments, minimum tolerance intervals apply only to medication orders.

A “future status,” as used herein, is a status of an order which represents that the order is not yet associated to an encounter. A “fuzzy” or “estimated” date, as used herein, is an estimated date and time as to when a procedure is to be done prior to that procedure being scheduled.

Embodiments hereof permit each treatment period (that is, each instance of a recurring order or group of orders) to be activated independently (e.g., on different encounters) even though the ordering activity for the treatment schedule (that is, all treatment periods or instances of the recurring order or group of orders) takes place only once. Relationships between orders within a recurring group or phase, as well as relationships between different instances of the group or phase (e.g., between treatment periods included in a treatment schedule wherein the same group of orders is to be executed on two different days) are established utilizing time offsets. Each time that a treatment period (i.e., an instance of the recurring order or group of orders) is activated, a new time zero is established and future administration times are calculated utilizing the time offsets with respect to the new time zero. Additionally, each time that a treatment period (i.e., an instance of the recurring order or group of orders) is activated and a new time zero is established, future treatment periods included in the treatment schedule are scheduled for future initiation based upon the time offsets.

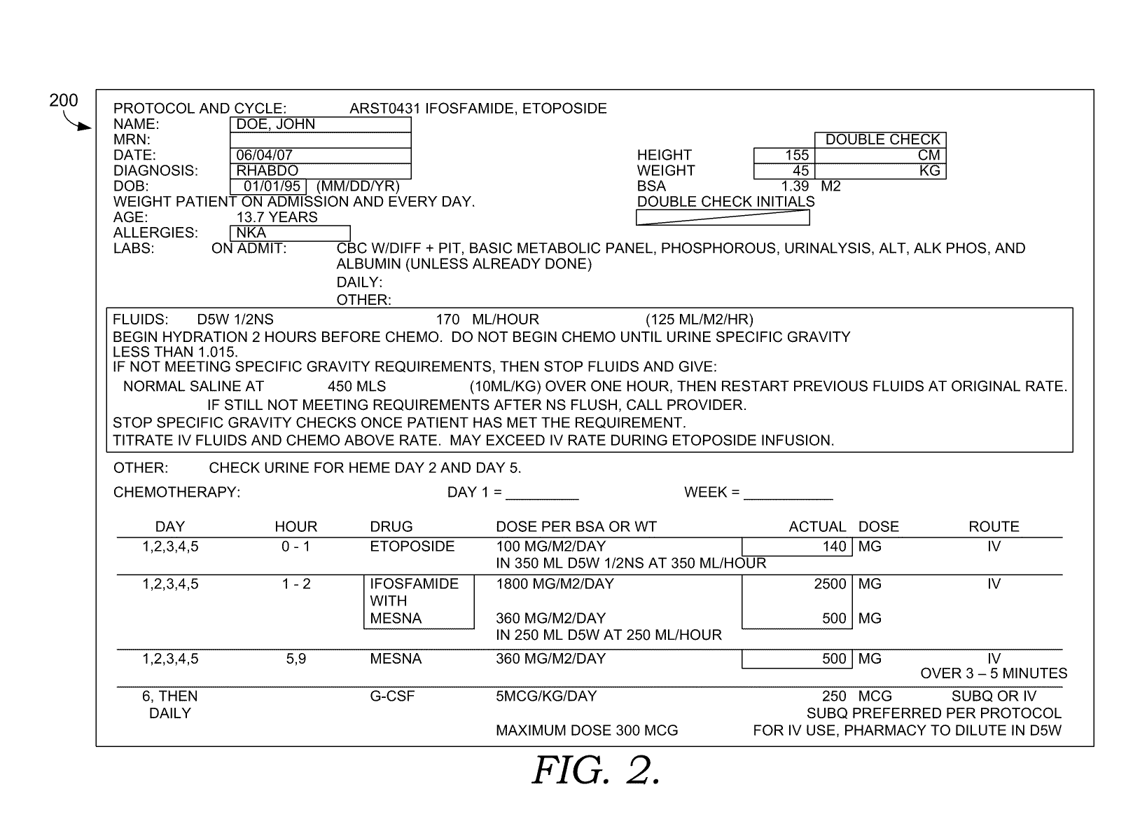

With reference to FIG. 2, a screen display is illustrated of an exemplary user interface 200 showing a sample treatment schedule having a repeatable group of chemotherapy orders assigned to a plurality individual treatment periods, in accordance with an embodiment of the present invention. The orders at the bottom of the screen display under the heading “Chemotherapy:” illustrate that each is to occur on multiple days. The box 210 near the center of the screen display shows pretreatment orders. Beneath the box 210, after the indicator of “other:” it is indicated that a lab order (urine check for heme) is to occur on days 2 and 5 of treatment. As such, when the group of orders is defined, not all orders will repeat with the same frequency. This exemplary user interface 200 illustrates that, in accordance with embodiments hereof, a user may define when each order is initiated individually but that all orders in the protocol are laid out so that the relationship between them is known and maintained.

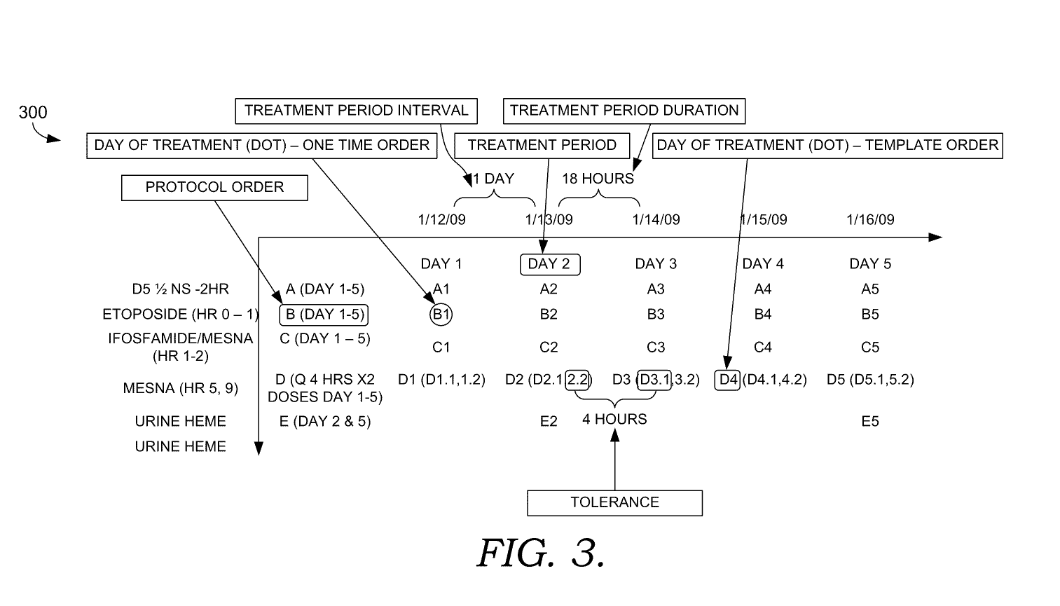

With reference to FIG. 3, a screen display of an exemplary schematic 300 illustrating the relationship between the series of orders delineated in FIG. 2 (represented by characters A, B, C, D, and E), in accordance with an embodiment of the present invention, is shown. As illustrated, order B is ordered to be carried out Day 1-Day 5 and is considered a protocol order. Orders B1 through B5 are individual orders that will be carried out on the specified treatment period and are considered day-of-treatment orders. Thus, while only input one time (with the order detail of Days 1-5 associated therewith), an instance of the order will be created for each of days 1, 2, 3, 4 and 5. Within each day, the order behaves as if it is an individual order. That is, within each day, the order may have its own frequency and other details. However, the higher level construct of “protocol order B” is maintained. Embodiments of the present invention support building the vertically-illustrated relationships—what is to be completed on Day 1, Day 2, etc.

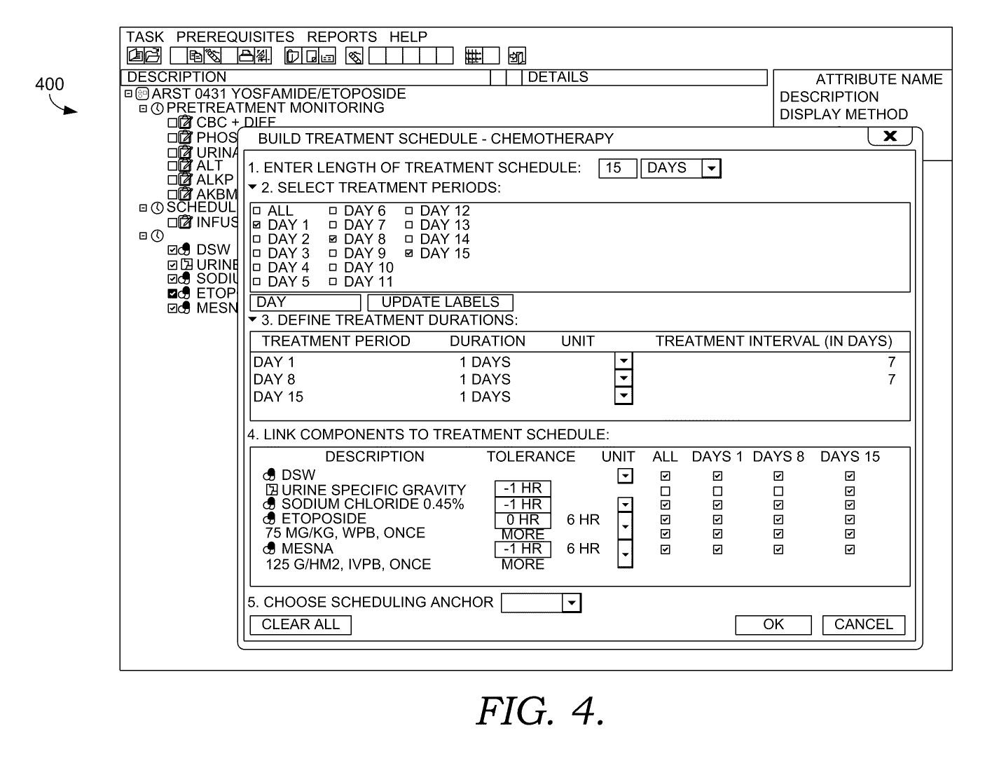

With reference to FIG. 4, a screen display is shown of an exemplary user interface 400, in accordance with an embodiment of the present invention, for use in building a chemotherapy treatment schedule having a plurality of treatment periods, at least some of which include recurring orders. All orders in the protocol or treatment schedule are illustrated and boxes are selected only for those treatment periods (Day 1, Day 8 and Day 15, as shown) on which each order is to be carried out. Treatment duration may also be defined.

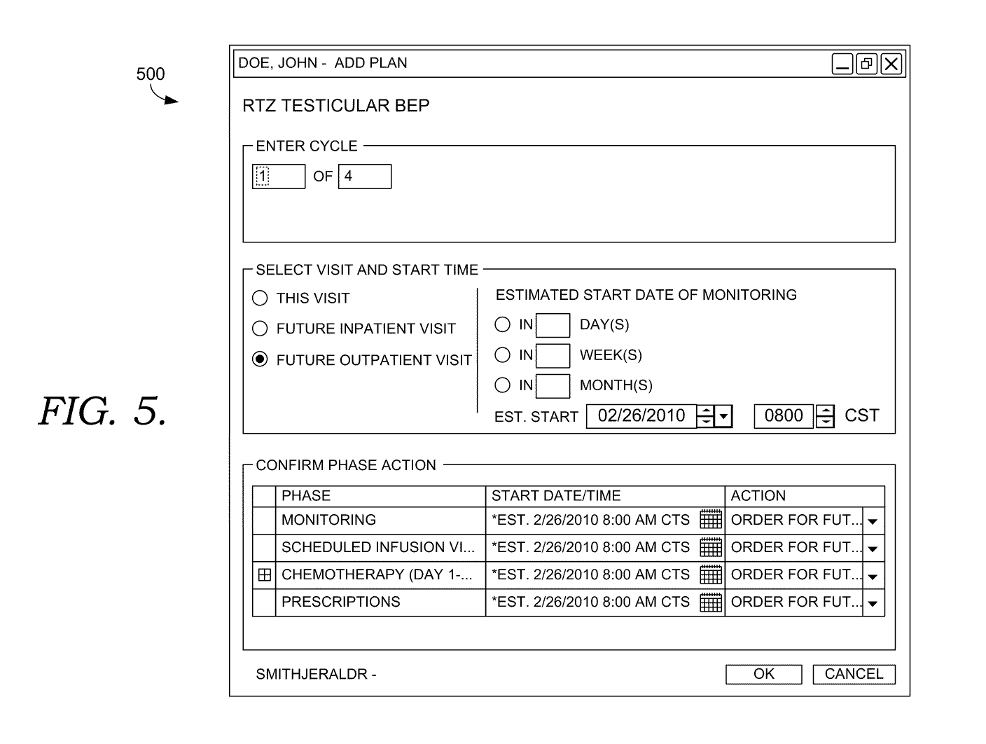

In accordance with embodiments hereof, when a healthcare plan with a treatment schedule is ordered, a dialog box is presented to the user. In embodiments, the dialog may be configured to capture and display pertinent information related to a plan with at least one phase having a plurality of recurring orders, for instance, a chemotherapy plan. With reference to FIG. 5, a screen display is shown of an exemplary add-plan dialog box 500 for a chemotherapy plan with at least one phase having a plurality of recurring orders. As illustrated, the dialog can capture and display cycle number information. Additionally, a provider can enter the nature of the visit for which administration of the cycle is scheduled to take place (as shown, such nature may be “This Visit,” “Future Inpatient Visit,” or “Future Outpatient Visit”) and estimated start date and time for the plan (either explicit or relative to the time of ordering). If a phase of the plan has a treatment schedule defined, the treatment periods assigned to the phase may be displayed next to the phase name in the dialog (e.g., “Chemotherapy (Day 1-6, 8, 15)”) and an expand/collapse icon 510 may be presented in front of the phases name.

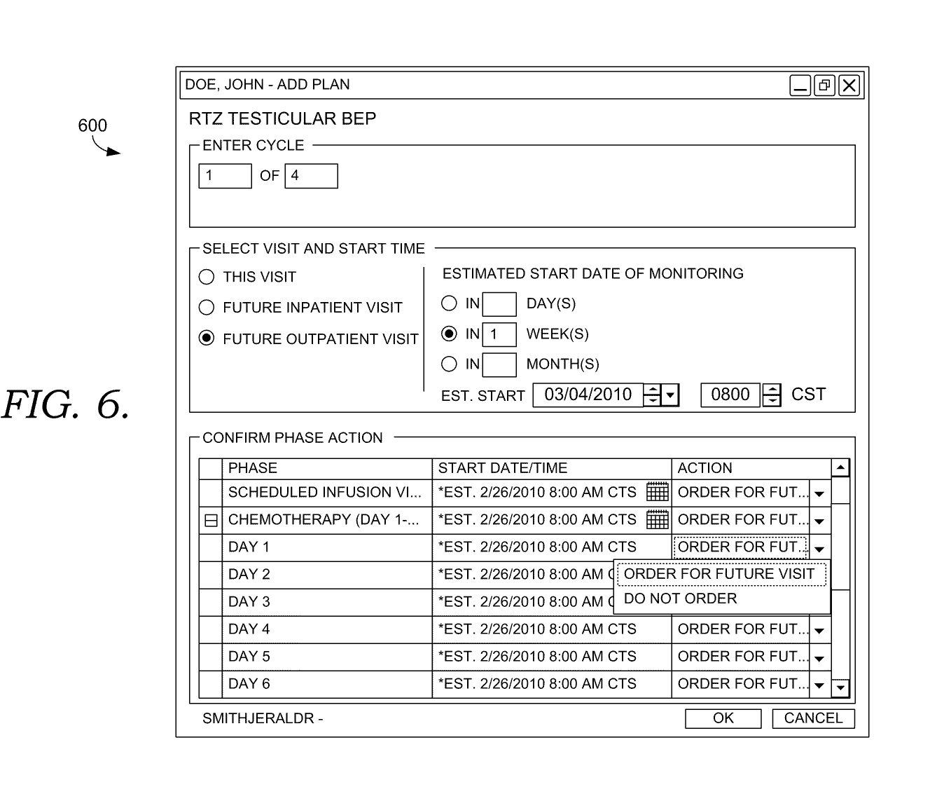

Turning to FIG. 6, a screen display is shown of an exemplary add-plan dialog box 600 for the chemotherapy plan of FIG. 5 once the expand/collapse icon 510 is selected. As shown, a list of the individual treatment periods (Day 1, Day 2, Day 3, Day 4, Day 5, Day 6, Day 8 and Day 15) and the estimated start date/times of the chemotherapy phase that is comprised of a plurality of recurring orders is presented. To change the start of the first treatment period, a user may enter a new date/time on the phase and the start date/time of the first and subsequent treatment periods will be adjusted accordingly. The action defaulted for each treatment period is the same as the action defined on the phase under the heading “Select Visit and Start Time.” In the illustrated instance, the default action is “Order for future [outpatient] visit.”

In embodiments, another selectable action option for a treatment period is “Do Not Order.” If “Do Not Order” is selected as an action for a treatment period, the orders linked to that treatment period will not be ordered. The ability to select “Do Not Order” for a treatment period may be useful when managing patient care across venues. For example, if a patient receives Day 1 and Day 2 of a chemotherapy treatment schedule in an outpatient setting and the patient condition changes so they require inpatient care, the provider can discontinue the plan at the outpatient venue and re-order the plan at an inpatient venue. When the plan is re-ordered, the provider can select “Do Not Order” for Day 1 and Day 2 preventing duplicate therapy from being ordered. Thus, the user interface 600 of FIG. 6 illustrates that each treatment period has its own identity and, accordingly, treatment can begin in the middle of a treatment protocol or schedule (for instance, if there is a facility change, or the like), in accordance with an embodiment of the present invention.

With reference to either FIG. 5 or 6, once the user selects the “OK” indicator 512 in the add-plan dialog box (500 or 600), the plan is added to the subject patient's profile. The phase that has the treatment schedule defined is presented in a single calendar-view that arranges the orders and outcomes horizontally down the left side of the profile and the treatment periods arranged in columns to the right of the orders and outcomes, one column for each treatment period. A generic example of this functionality is shown with reference to the schematic 300 of FIG. 3.

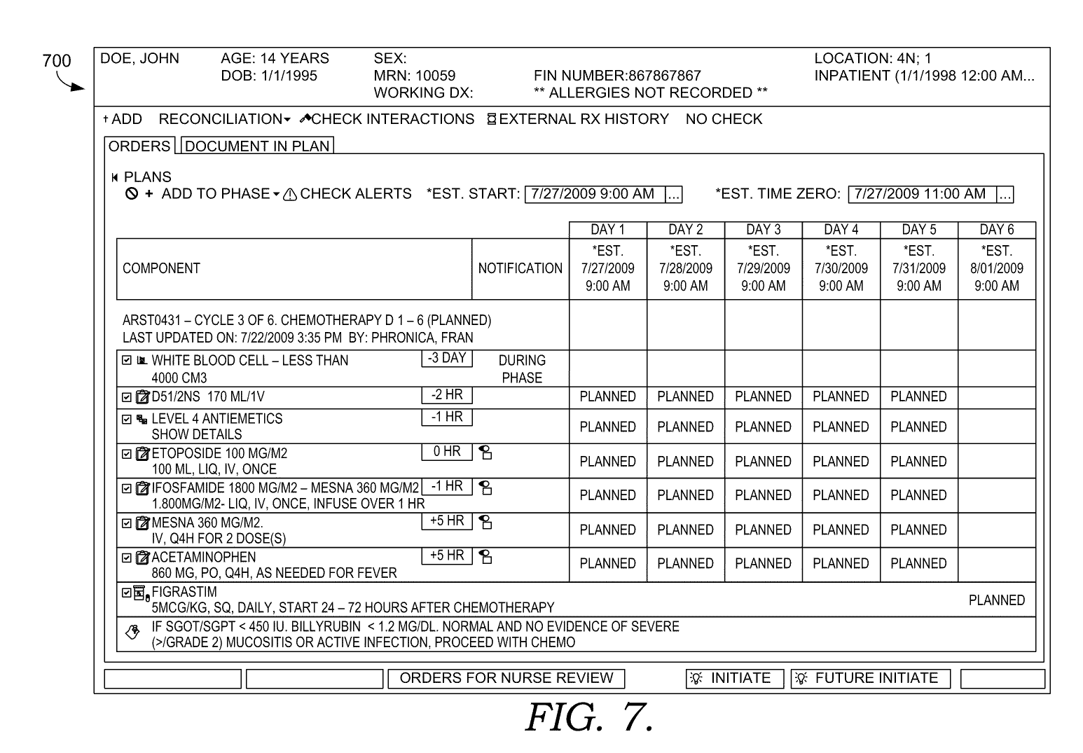

With reference to FIG. 7, a screen display is shown, in accordance with an embodiment of the present invention, illustrating an exemplary user interface 700 showing a calendar-view of a planned phase of treatment, the phase orders placed in accordance with embodiments hereof. As illustrated, a healthcare plan has been ordered, a chemotherapy phase, that has a schedule to it. Instead of just showing a list of orders, a matrix is shown constructed from the orders and the days of treatment. Thus, the user interface 700 illustrates the list of orders, per day of treatment, and how they fall out. This single, calendar-view gives a clinician an idea of what orders are in the entire healthcare plan and how they are going to be carried out each day.

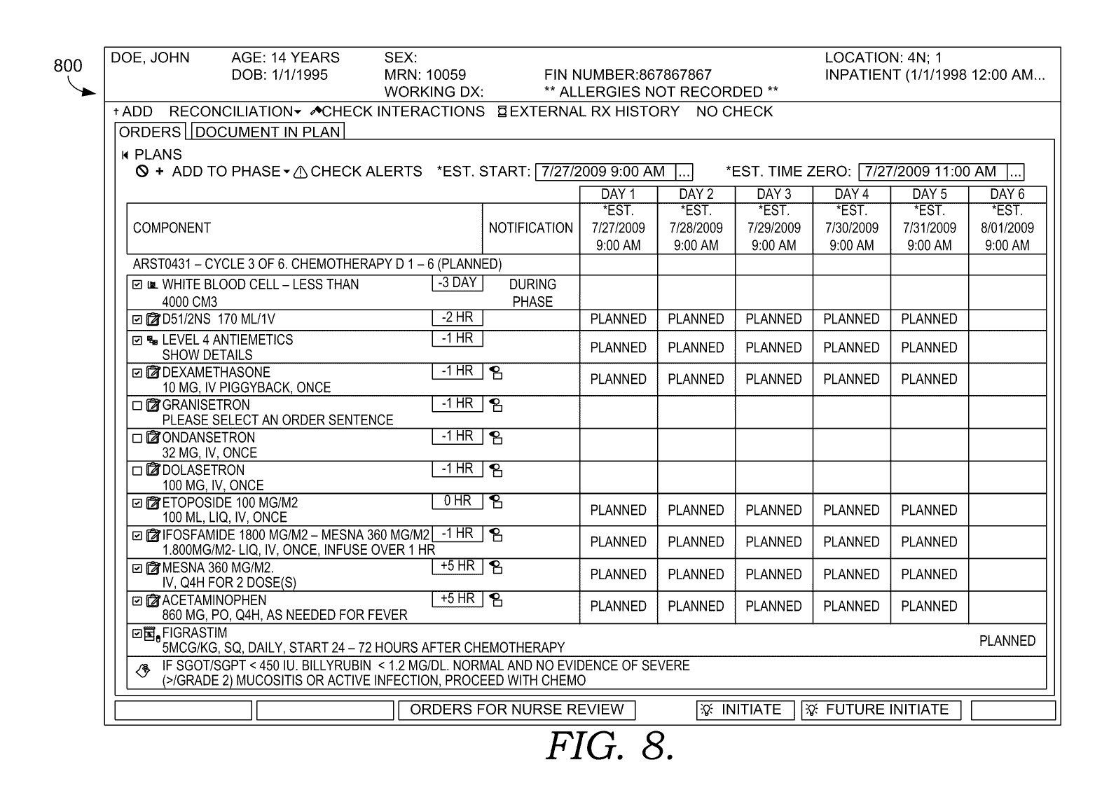

As illustrated, if an order or outcome is assigned to a treatment period, the text “Planned” is presented in the column representing the treatment period to which it is assigned. In embodiments, this functionality only applies when a check box in front of the order or outcome is selected. Thus, in the screen display 800 of FIG. 8, the text “Planned” appears in the treatment period columns for only a portion of the orders/outcomes listed down the left side thereof. In embodiments, if the order or outcome is not included, the row may be shaded a different color (or otherwise have a differentiating indicator) indicating that the order is not expected to be carried out during the treatment period.

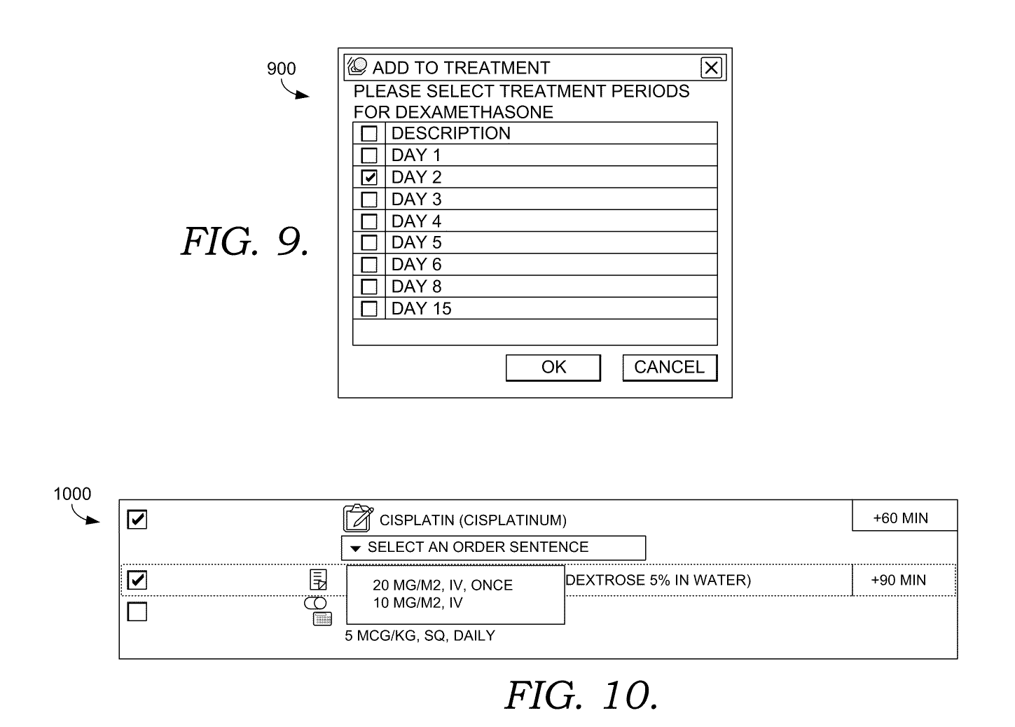

With continued reference to FIG. 8, to add an item to a particular treatment period, a user may select the “Add to Phase” menu option in the toolbar 810 and then select “Add Order,”:Add Outcome,” or “Add Prescription” from the presented sub-menu (not shown). (As an alternative (shown with reference to FIG. 14), the user may select the “Action” menu 1410 under a treatment period column and select the same options.) Once the user has selected to add to the phase or treatment period, a dialog 900 displays prompting the user to select which treatment period the order, outcome, or prescription is to be added. This is shown in the screen display of FIG. 9. In embodiments, orders and outcomes may be added to multiple treatment periods but prescriptions may only be added to one treatment period. Only the treatment periods that are defined in the build of the plan are available for selection. In embodiments, if a treatment period has been completed or discontinued, the treatment period appears disabled in the “Add to Treatment Periods” dialog 900 and is not available for selection (e.g., “Day 1” as illustrated in FIG. 9). To quick select all treatment periods, the user may select the check box 912 next to the description field once. (Note that in some embodiments, this action is not valid for prescriptions since, as previously set forth, prescriptions may be added to only one treatment period). If the check box 912 is selected a second time, all treatment periods will be unselected.

In embodiments, when the “Add Order” menu option is selected from the “Action” menu for a specific treatment period (for instance, with reference to menu 1410 of FIG. 14), the treatment period is automatically selected in the “Add to Treatment Periods” dialog 900. If selected from the toolbar (for instance, toolbar 810 of FIG. 8), no treatment period is selected by default.

In embodiments, within the treatment schedule view, order sentences may be presented below the order mnemonic. In such embodiments, a visual indication is presented before the order sentence if there is more than one order sentence predefined. This is shown in the screen display 1000 of FIG. 10. Selecting the order sentence row presents the pre-defined order sentences. Additionally, if the attribute “No Default Order Sentence” is selected for the order sentence in the treatment build tool, the text “Select an Order Sentence” may be presented, as shown.

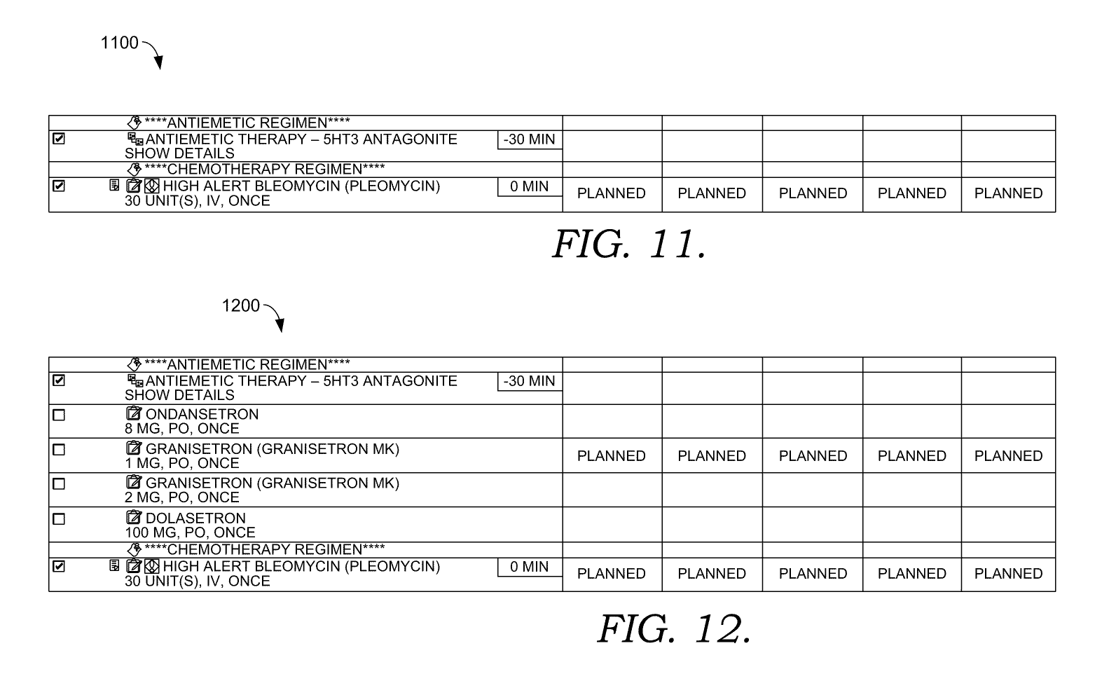

As shown in the screen displays 1100 and 1200 of FIGS. 11 and 12, respectively, in embodiments, phases having one or more sub-phases may have names that are presented with the text “Show Details” 1110 (FIG. 11) or “Hide Details” 1210 (FIG. 12) below the name. “Show/Hide Details” acts as a hyperlink and opens or closes the sub-phase to view the content available for customization. As shown in FIG. 12, when “Show Details” is selected, the contents of the sub-phase are presented. In embodiments (not shown), the sub-phase contents are grouped by a background color to indicate where the sub-phase orders start and stop within the phase. Once “Hide Details” is selected, the user is returned to the previous view shown in FIG. 11.

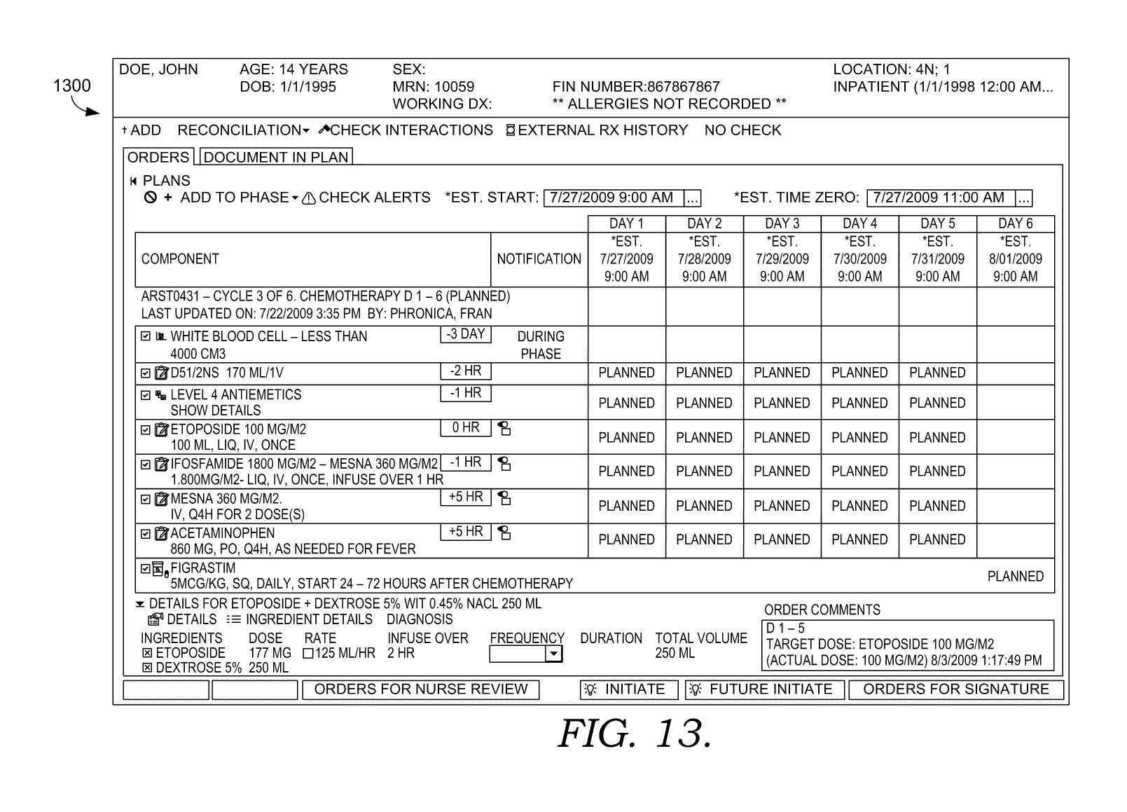

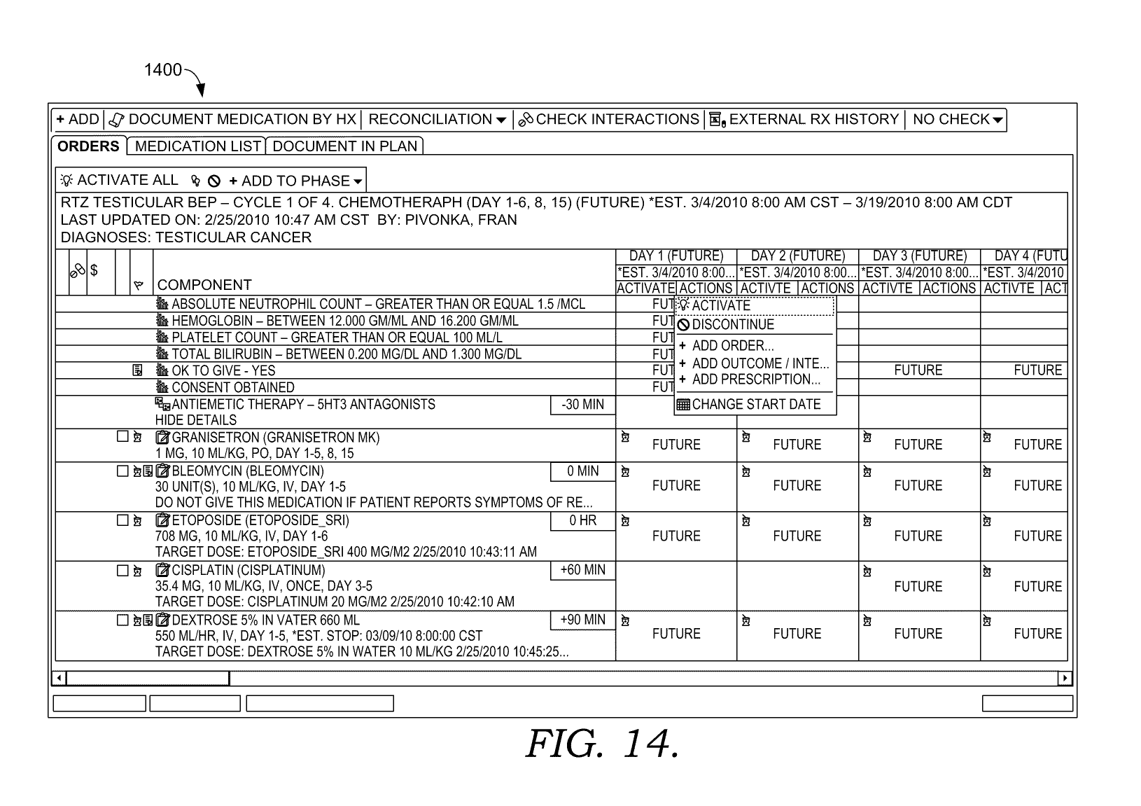

With reference to FIG. 13, a screen display is shown of an exemplary user interface 1300 illustrating how orders within a healthcare phase placed in accordance with embodiments of the present invention may be initiated or future initiated, in accordance with an embodiment of the present invention. Once the chemotherapy phase is “Initiated” 1310 or “Future Initiated” 1312, the treatment schedule view displays the status of the individual orders for each treatment period. This is shown in the screen display 1400 of FIG. 14.

If the phase is initiated, then all treatment periods and orders within the treatment periods are associated to the encounter open at the time the phase is initiated. If the phase has been “Future Initiated,” the orders in a treatment period can be activated on different encounters. In embodiments, there are two options for activating treatment periods, “Activate All” 1410 and “Activate” 1412. As illustrated, “Activate All” is a selectable button 1410 on the toolbar above the phase which activates each treatment period and associates the orders in each treatment period for the current encounter. Selecting the “Activate” button 1412 for a specific treatment period associates the orders from the treatment period to the current encounter. Subsequent treatment periods are left in a “Future” status to be activated on different outpatient encounters. In embodiments, to activate treatment periods across encounters, the encounters must be associated to the same facility.

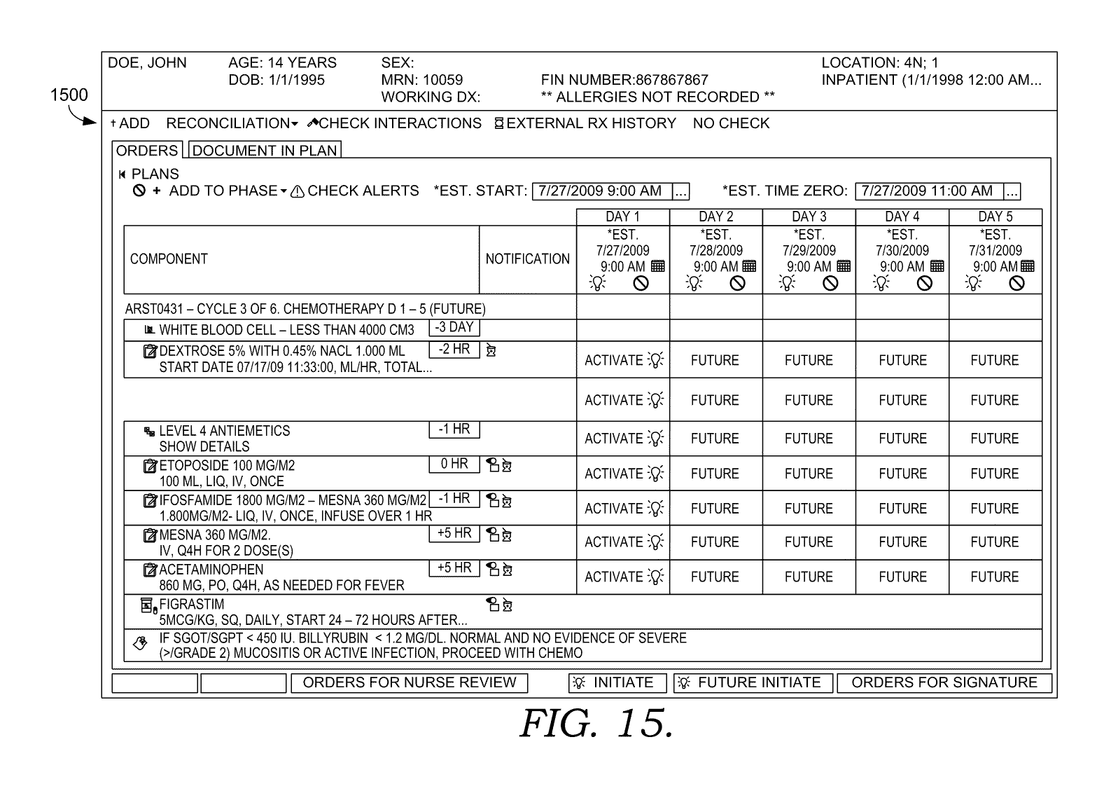

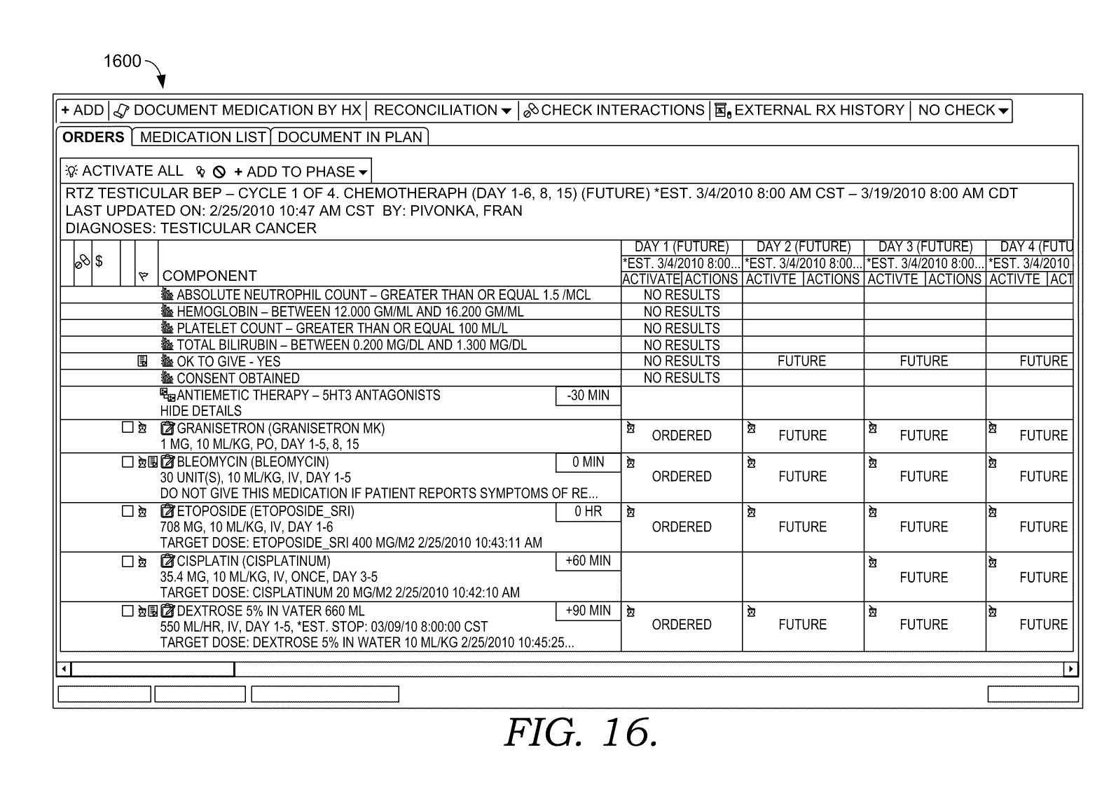

Once a treatment period is activated, the orders being activated are presented, as shown in the screen display 1500 of FIG. 15. After the orders are signed and the user refreshes the profile, the activated treatment period status is updated from “Future” to “Initiated” and the orders are in a status of “Ordered.” This is shown in the screen display 1600 of FIG. 16.

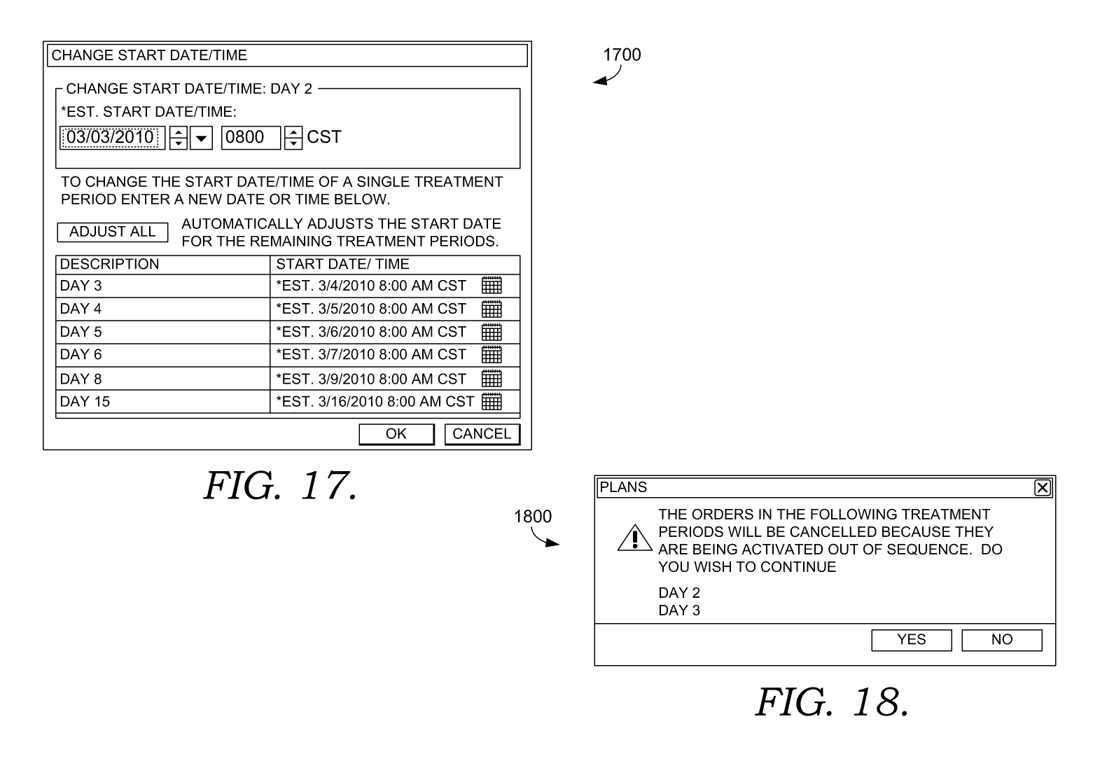

Note that in embodiments, if the start date/time of the treatment period being activated is more than one day in the past, a “Change Start Date/Time” dialog 1700 opens and allows the user to set a new date/time for the treatment period, as shown in the screen display of FIG. 17. In embodiments, the date/time of the treatment period being activated defaults into the top portion of the “Change Start Date/Time” dialog 1700. The user may change the start date/time and select the “Adjust All” indicator 1710 which adjusts the date for each treatment period but not the time. Alternatively, the user may manually adjust the dates/times for each treatment period. If a treatment period is moved such that it is out of sequence, for example, the start of Day 4 is moved before the start of Day 3, a red exclamation mark (or other error indicator) may be presented in front of the treatment period to indicate than an error has occurred. In embodiments, message text may be presented when the user hovers over the error indicator. Further, in embodiments, the “Change Start Date/Time” dialog 1700 may also be accessed by selecting the “Change Start Date/Time” indicator from the “Actions” menu for a specific treatment period (for instance, the “Change Start Date/Time” indicator 1414 of FIG. 14). In embodiments, the dialog 1700 behaves the same when accessed from the “Actions” menu or when it automatically opens during activation.

Turning now to the screen display 1800 of FIG. 18, if a treatment period is activated out of sequence, a warning message may be presented to notify the user that the treatment periods that have not been activated will be canceled. In the illustrated example, “Day 4” is activated and the warning message indicates that Day 2 and Day 3 which still have a status of “Future” will be canceled.

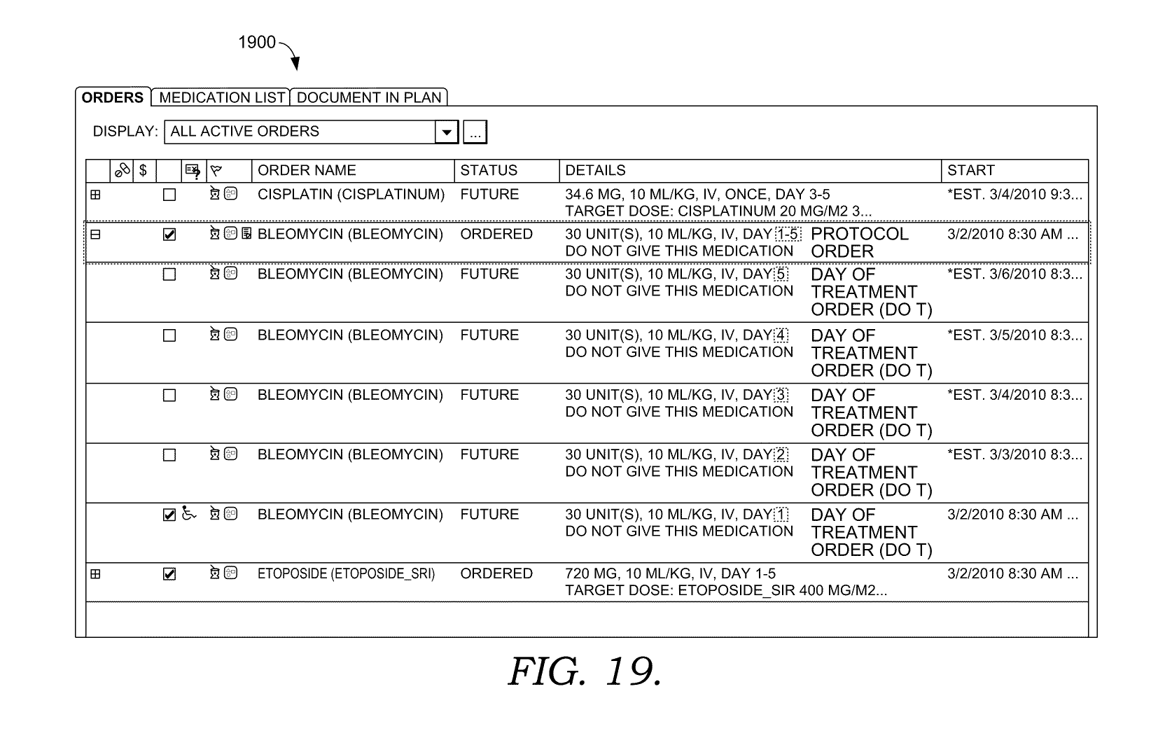

Orders that originate from a plan contain a treatment schedule display in the order profile similar to continuing or parent/child orders. There is one order spanning multiple treatment periods which groups the orders from each treatment period. The order spanning multiple treatment periods is considered the protocol order. In embodiments, the protocol order presents the summary of the assigned treatment periods on the clinical display line and grouped below the protocol order are the orders assigned to the individual treatment periods. As previously set forth, these orders may be referred to as day-of-treatment orders. In embodiments, the day-of-treatment orders present only the treatment period assigned to the order on the clinical display line. With reference to the screen display 1900 of FIG. 19, “Bleomycin Day 1-5” is the protocol order and spans five treatment periods. The orders grouped under “Bleomycin Day 1-5” are considered the day-of-treatment orders.

As previously set forth, protocol orders are defined to occur during specific treatment periods within the phase schedule of a chemotherapy plan and they are associated to either a day-of-treatment template order or a day-of-treatment one-time order. In embodiments, when a phase with a treatment schedule is initiated or future-initiated creating protocol and day-of-treatment orders, interaction checking occurs against the protocol order. In embodiments, actions of “Modify,” “Void,” and “Cancel/Discontinue” may be taken on protocol orders, e.g., chemotherapy plans, as more fully described below.

In embodiments, to modify a protocol order across the entire treatment period, users may right-click the name of the order and select “Modify.” Modifications made to the protocol order are propagated to day-of-treatment orders that are active. In embodiments, to modify the order for a specific day only, users may right-click the individual day and select “Modify.” The start date/time of the order determines how the modifications affect the order. For instance, if the protocol status is “Future” and a user selects a “Modify” action, the modifications may be applied to each day-of-treatment order. If the protocol status is “Ordered” but the start date/time is in the future and the user selects a “Modify” action, the modifications may be applied to each day-of-treatment order. If the protocol status is “Ordered” and the start date/time is in the past and the user selects a “Modify” action, the modifications may be applied to all active, incomplete, and future day-of-treatment orders having a stop date/time that is not in the past. If the stop date/time for the day-of-treatment order is in the past and it is a “Non-PRN” one-time order, the day-of-treatment order may be updated with the modifications. If the day-of-treatment order is not a one-time order (e.g., a continuing, continuous, IV, or PRN order, or the like), the day-of-treatment orders having a stop date/time that is in the past may not be updated when the user selects a “Modify” action. If the protocol status is “Ordered” and the start date/time is in the past, when the user modifies the frequency or changes the order from “PRN” to “Non-PRN,” the modifications may be applied to the current day-of-treatment order and all day-of-treatment orders with a start date/time in the future. If the protocol status is “Ordered” and the start date/time is in the past, when the user modifies the duration, the new value may be applied to all day-of-treatment orders with a start date/time in the future. The new duration value may not be applied to the current day-of-treatment order.

In embodiments, users can void medication and non-medication protocol orders. When users select to void a protocol order, all orders in the past and future that are associated to the protocol order also are voided. In embodiments, to void an order, users may right-click the order at the protocol level and select “Void,” or select the order and then select “Void” from the current menu.

Users may perform a “Cancel/Discontinue” action on protocol orders. In embodiments, to cancel or discontinue an order, users may right-click the order and select “Cancel/Discontinue,” or select “Cancel/Discontinue” from the current menu. For instance, when canceling or discontinuing protocol orders, if the protocol order is in a status other than “Future,” all orders that are scheduled in the future, are not end-stated, and that are eligible may be updated to a “Canceled” status. Orders that are scheduled in the past with a stop date and time in the future may be updated to a “Discontinued” status. If the protocol order contains a single day-of-treatment one-time order, it may be updated to a “Discontinued” status, even though the stop date/time is in the past. Day-of-Treatment orders may also be canceled or discontinued.

In embodiments, for day-of-treatment one-time orders, if the order is in an “Ordered” status and the start and stop date/time is in the past, the orders may remain in an “Ordered” status. For continuing day-of-treatment orders, if the order is in an “Ordered” status and the start and stop date/time is in the past, the day-of-treatment orders may be updated to a “Pending/Complete” status. If the day-of-treatment template order is in a “Future” status, all child orders associated to that template may be updated to a “Canceled” status even if they are in the past. If a day-of-treatment template order is in a status other than “Future,” all child orders associated to that template may be updated to a status of “Future” and orders scheduled in the past may not be changed. If a user cancels or discontinues a child order (only allowed for non-medications) or a one-time order, only that particular order may be cancelled.

As previously set forth, a day-of-treatment order may be either a one-time order or a template order, which is the grouper order that indicates when clinical activity is to occur more than once a day. Both orders are associated to the protocol order and the template order always has child orders. In addition to the Cancel/Discontinue action, day-of-treatment level orders may also be completed or rescheduled.

In embodiments, if a medication or non-medication is a one-time order, users may complete the order at the day-of-treatment level. To complete the order, users may right-click and select “Complete.” Users may also select the order and select “Complete” from the current menu.

In embodiments, users may reschedule a day-of-treatment order, but may receive a warning message if one of two situations occurs. First, if the user causes the stop date/time to exceed the defined treatment period duration (for medication and non-medication orders), a warning message may be received. Secondly, if the user causes the last dose for an order to become too close to the subsequent first dose for the day-of-treatment order as defined by the minimum tolerance interval (for medication orders), a warning message may be received.

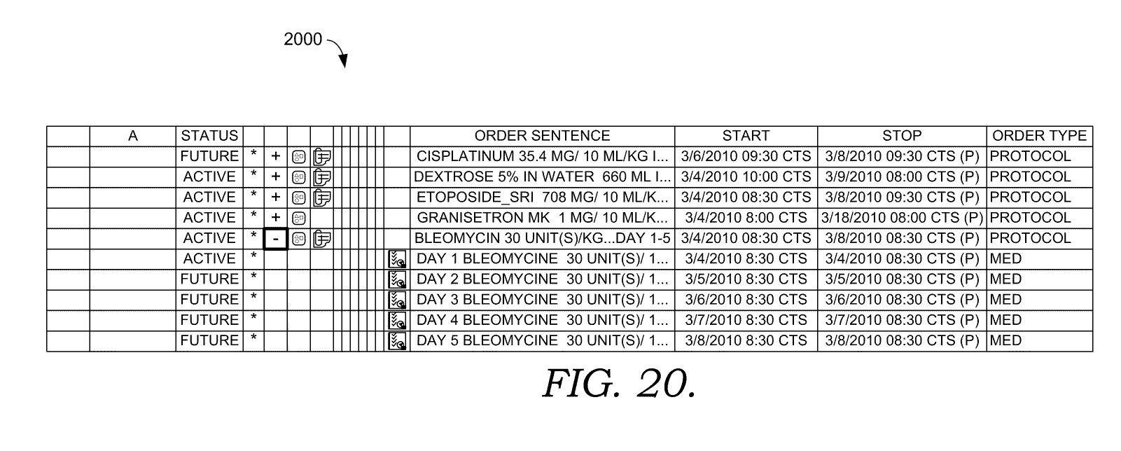

Electronic medication management applications may by default present the protocol order with the assigned treatment periods in the order sentence. The order type on a protocol order is “Protocol” which differentiates it from a day-of-treatment order. Selecting the “+” sign expands the protocol order to display the day-of-treatment orders that are related. This is shown in the screen display 2000 of FIG. 20. In embodiments, when a protocol order is verified, any modifications made to the protocol order during verification may be applied to the day-of-treatment orders. In embodiments, the following actions may be supported for a protocol order in an electronic medication management program: “Cancel,” “Discontinue,” “History,” “Inquire,” “Intervene,” “Modify,” “Reject,” “Void,” “Verify/Accept,” and “Product Assign/Clinical Review.” In embodiments, the following actions may be supported for a day-of-treatment order in an electronic medication management program: “Cancel,” “Discontinue,” “History,” “Inquire,” “Intervene,” “Label,” and “Reschedule.”

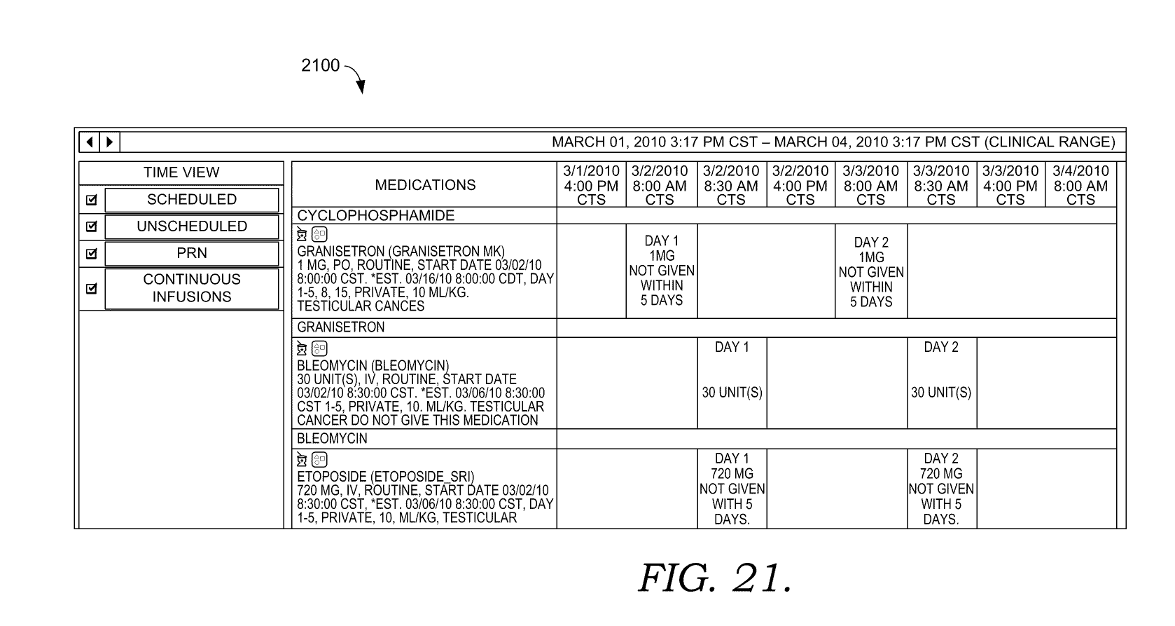

In embodiments, protocol orders may be presented in a “Medications” column of an electronic medical record. In such embodiments, the protocol order may present the assigned treatment periods in the clinical display line of the order to clarify when medications are expected to be administered. The tasks displayed in the date/time columns represent tasks generated by the day-of-treatment orders and display the assigned treatment period on the task. In the example shown in the screen display 2100 of FIG. 21, granisetron is assigned to Day 1-5, 8 and 15; Bleomycin is assigned to Day 1-5; and etoposide is assigned to Day 1-5. Tasks are created for Day 1 and Day 2. In embodiments, any treatment period orders that are in a “Future” status will not create tasks. Instead, as soon as the treatment period is activated, tasks will be generated for the treatment period.

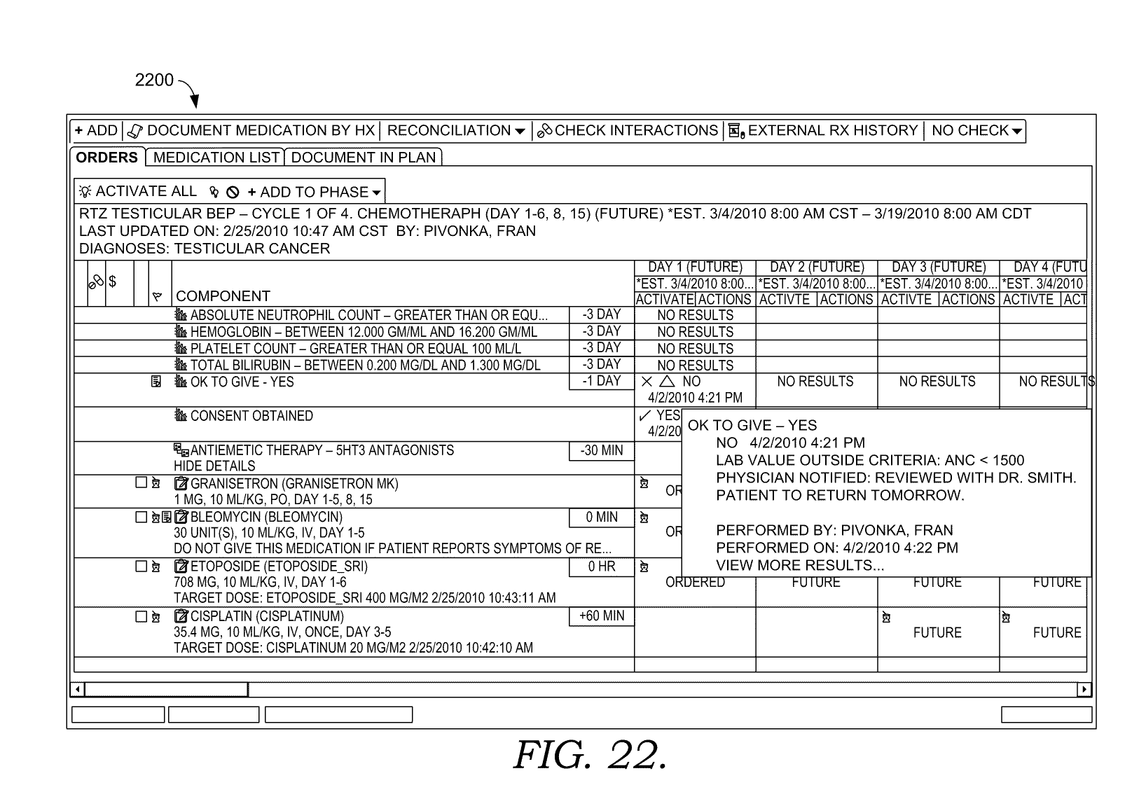

Outcomes in a treatment schedule phase present a unique set of results for each treatment period. In embodiments, if a result is not found for a treatment period, the text “No Result” may be presented. Otherwise, the treatment period presents the most recent result value, the indicator that determines whether the result value meets the expectation, the date/time of the result and indication of a variance or outcome note. In embodiments, to view the variance information related to a result, users may hover over the corresponding treatment period to present a tool tip containing variance information. Users may also double-click the treatment period cell to view additional outcome results. This is shown in the screen display 2200 of FIG. 22.

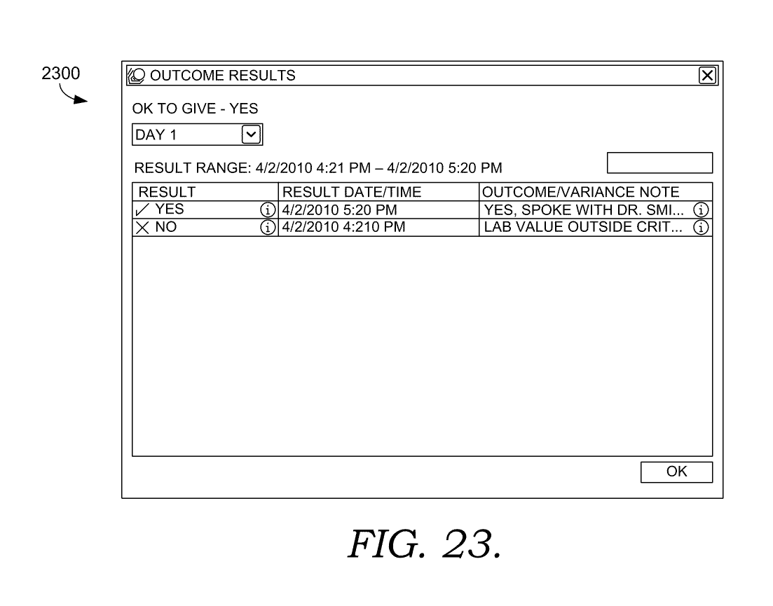

In embodiments, if “View More Results” is selected in the tool tip 2210 or the user double-clicks on the treatment period cell for the outcome result, the outcome results window presents a list of results based on the result range on the initial load. If there are additional outcome results that did not load, the “Load More” button may be enabled. Selecting “Load More” loads additional results until all results for the treatment period are presented. If the outcome is assigned to multiple treatment periods, users may view results from a different treatment period by selecting the treatment period from the drop down menu. This is shown in the screen display 2300 of FIG. 23.

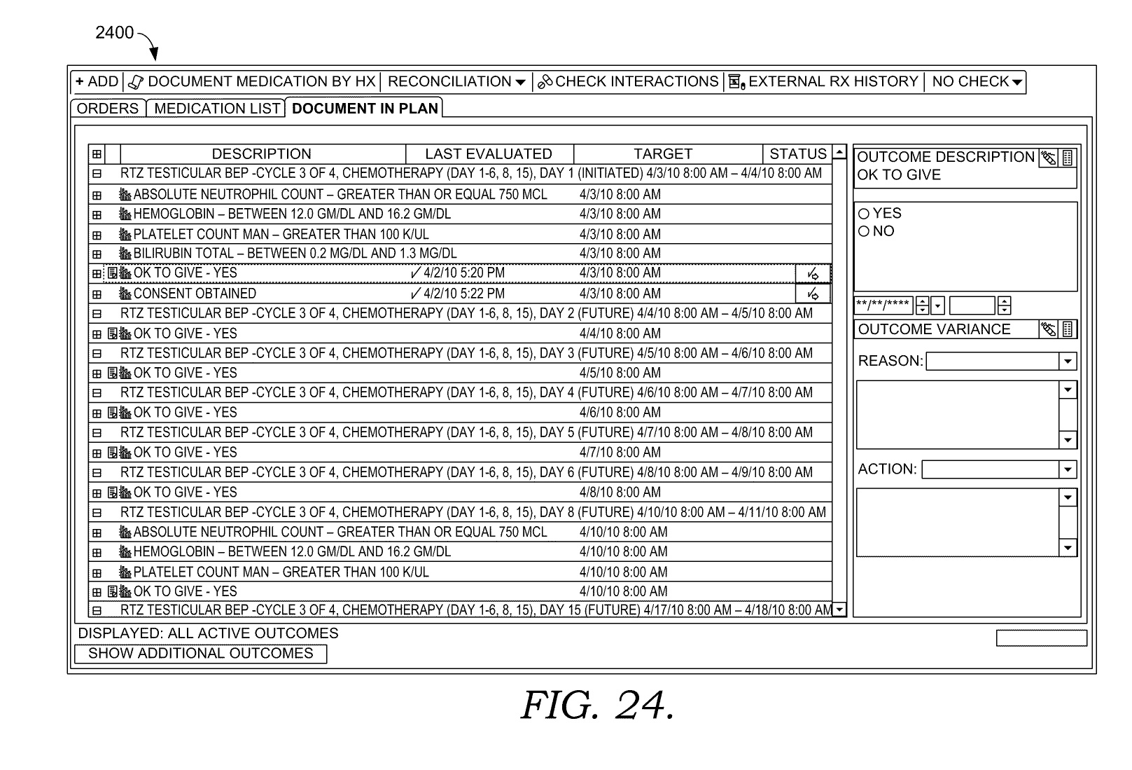

Within the electronic medical document, outcomes assigned to treatment periods may be grouped by the name of the treatment period and sorted in ascending order, as shown in the screen display 2400 of FIG. 24. In the illustrated screen display 2400, the outcomes for Day 1 display above the outcomes for Days 2, 3, 4, 5, 6 and 8.

In embodiments, the abilities to discontinue orders across all treatment periods or discontinue an individual treatment period are supported in accordance with embodiments of the present invention. To discontinue orders from all treatment periods, users may select the “Discontinue” option above the phase or right-click on the phase name in the navigator. The “Discontinue” dialog opens and presents the protocol orders and outcomes. The protocol orders and outcomes present the summary of treatment periods being discontinued in the details.

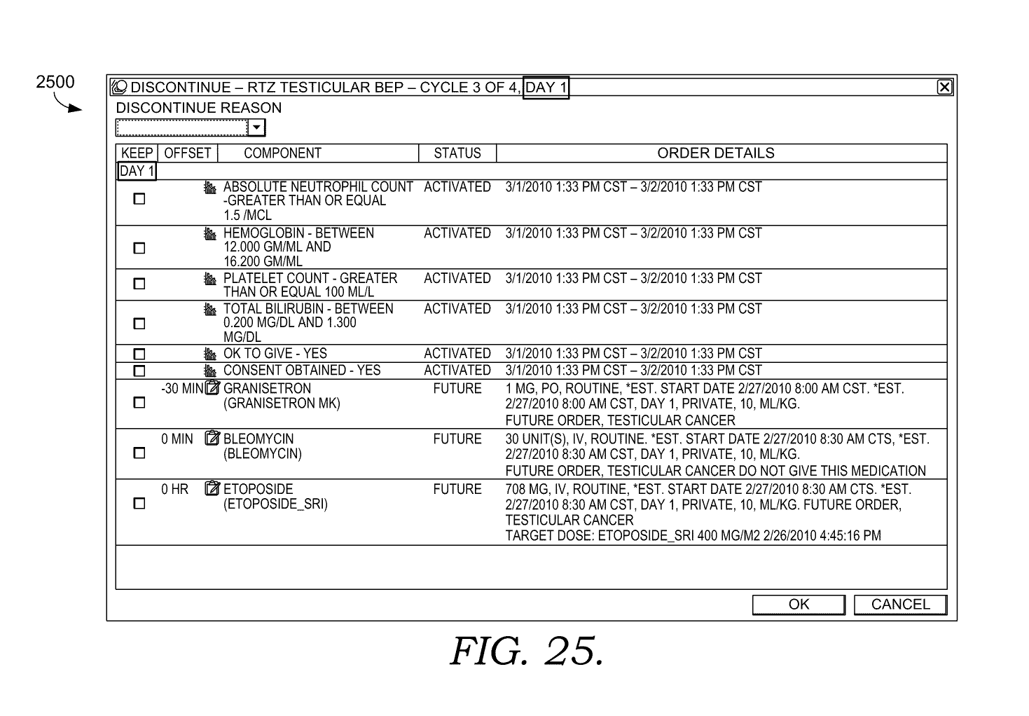

In embodiments, to discontinue orders for a specific treatment period, users may select the “Discontinue” option from the “Actions” menu in the selected treatment period column. This is shown with reference to FIG. 25. The “Discontinue” dialog 2500 opens but only presents the orders for the selected treatment period. The treatment period being discontinued is presented in the banner bar, the label above the orders and outcomes in the “Discontinue” dialog 2500 and the details section of the “Discontinue” dialog 2500.

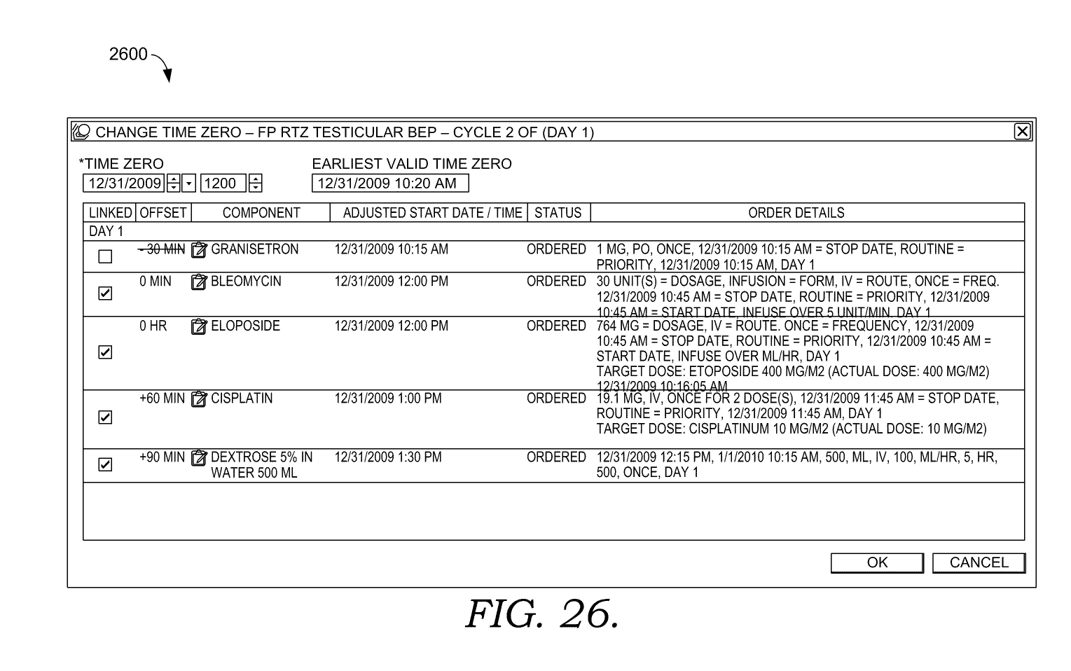

In embodiments, the “Change Time Zero” menu option for a treatment period is only available when the orders in a treatment period are in an “Ordered” status and the treatment period has started, but the start of the time zero order is still in the future. Once “Change Time Zero” is selected, the “Change Time Zero” dialog 2600 is presented (as shown in the screen display of FIG. 26) and users may enter a new date/time for time zero. In embodiments, unless the user deselects the order, all orders in the treatment period will have an adjusted start date/time based upon the new time zero. In embodiments, if the start of the treatment period is in the future, the only option available is “Change Start Date/Time,” selection of which will adjust all the orders in the treatment period.

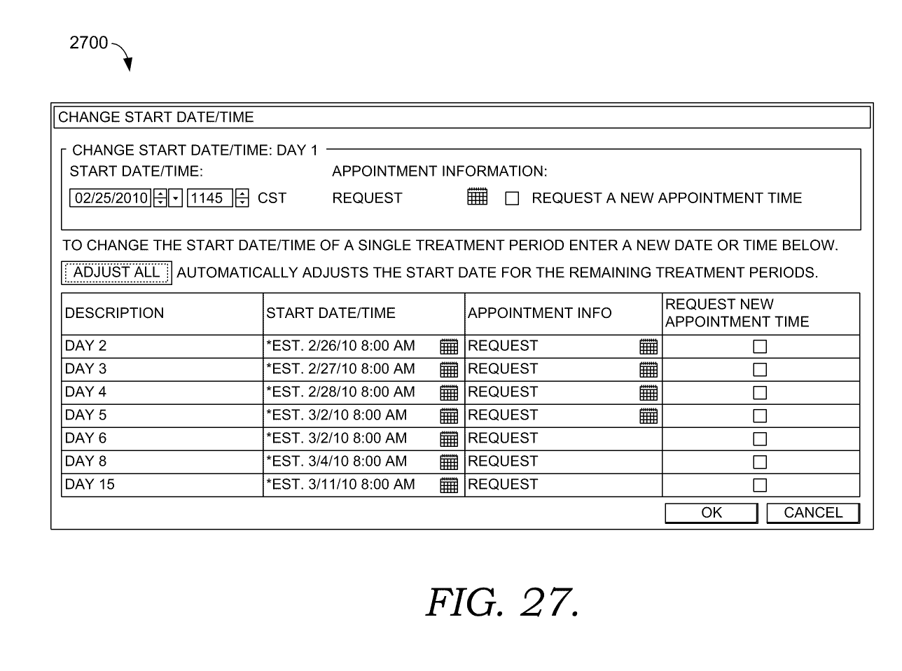

In embodiments, scheduling orders included in a phase of a plan can be linked to treatment periods of, for instance, a chemotherapy treatment schedule. Once an appointment linked to a treatment period is confirmed, the treatment period start date/time is updated with the appointment date/time. Additionally, when users change the start date/time of a treatment period, linked appointment information may be presented in the “Change Start Date/Time” dialog, as shown in the screen display 2700 of FIG. 27. In embodiments, the ability to request a new appointment time is dependent on additional scheduling build. If the additional scheduling build is not defined, a new appointment request is not sent to scheduling.

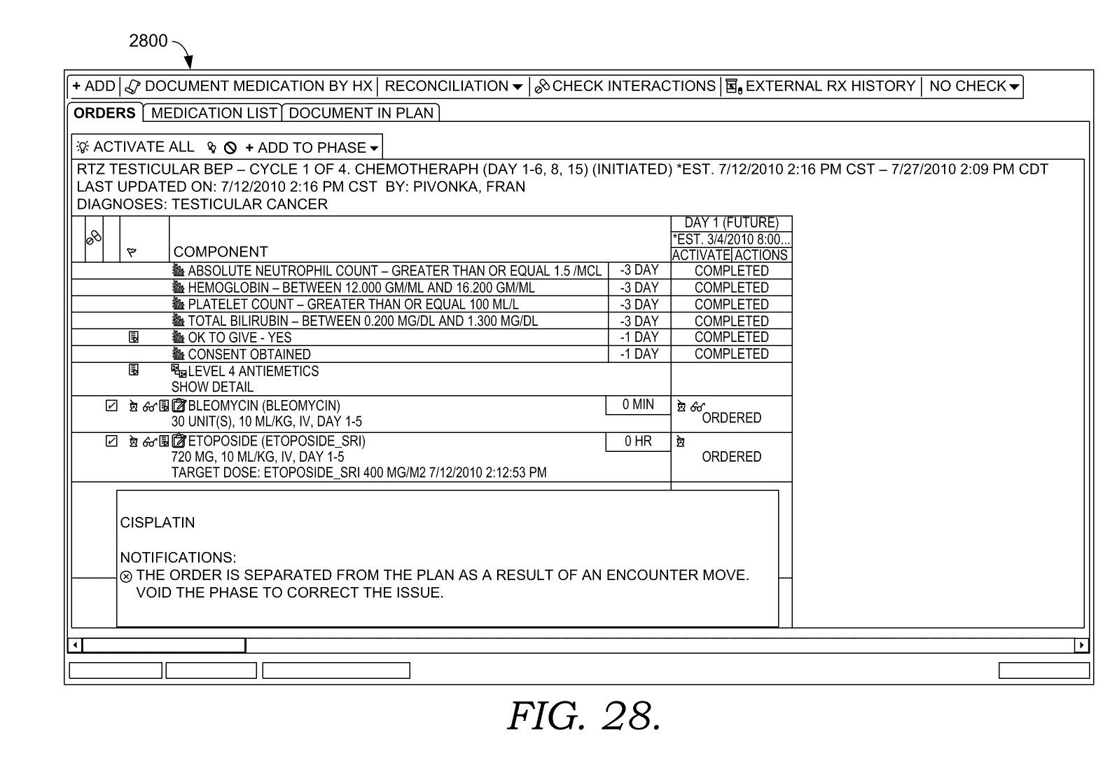

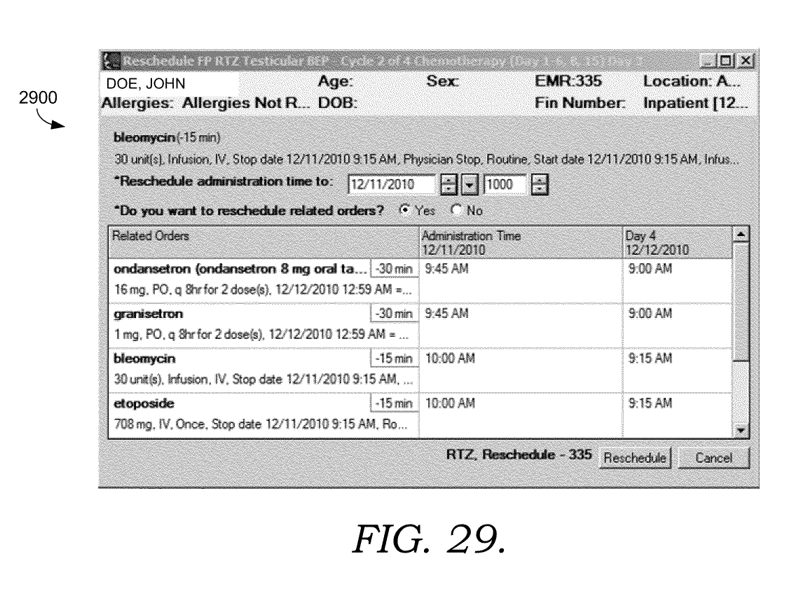

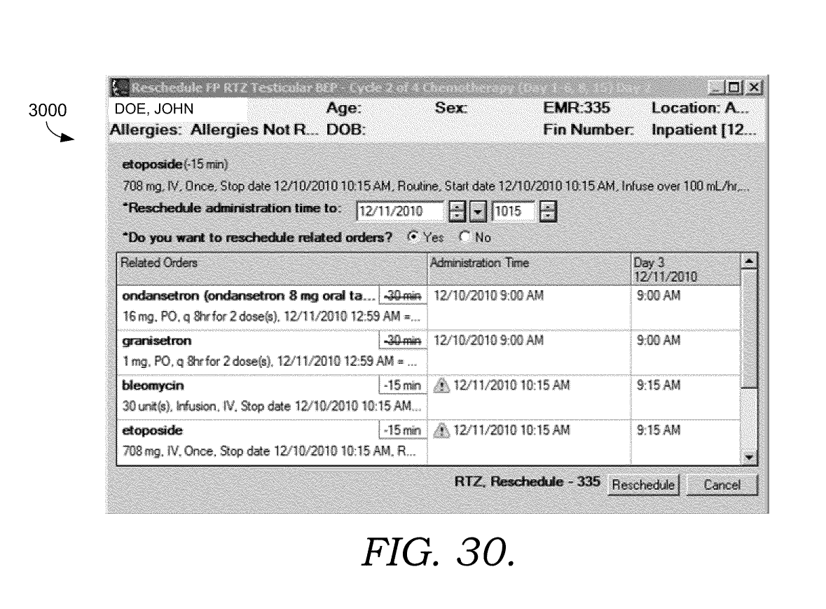

Orders in a plan may be rescheduled in the electronic medical record. In embodiments, a user may select the order he or she wishes to reschedule, right-click the order, and select “Reschedule Admin Times” from the menu. A list of different days may be presented depending on the order selected. The user may then select the day of the order he or she wishes to reschedule. A rescheduling window, such as window 2800 shown in FIG. 28, may then be displayed. The user may then make any changes to the date and time of the order. In embodiments, all proceeding orders listed will automatically update depending on the new date and time listed. The user may then select “Reschedule” and the new orders are created on the plan, as shown in the screen display 2900 of FIG. 29.

It should be noted that, in embodiments, if the user wants only to reschedule the order selected and not the other related orders on the plan, he or she may select “No” from the “Do you want to reschedule related orders?” option 2910 shown in FIG. 29.

Any broken orders in the plan will generally not update when the dates and times are changed. In embodiments, if a user makes changes to the orders that potentially overlap with other orders, a warning symbol may be presented in the Administration Time” column. Selection of “Reschedule” will then present a warning message. The user may position the cursor over the warning icon for more details on the warning.

As can be understood, embodiments of the present invention provide computerized methods and systems in a clinical computing environment for collectively ordering recurring orders, e.g., chemotherapy protocols where the same group of medications is to be administered in the same order multiple times over the course of several days. Embodiments hereof permit each treatment period (that is, each instance of a recurring order or group of orders) to be activated independently (e.g., on different encounters) even though the ordering activity for the treatment schedule (that is, all treatment periods or instances of the recurring order or group of orders) takes place only once. Relationships between orders within a recurring group or phase, as well as relationships between different instances of the group or phase (e.g., between treatment periods included in a treatment schedule wherein the same group of orders is to be executed on two different days) are established utilizing time offsets. Each time that a treatment period (i.e., an instance of the recurring order or group of orders) is activated, a new time zero is established and future administration times are calculated utilizing the time offsets with respect to the new time zero. Additionally, each time that a treatment period (i.e., an instance of the recurring order or group of orders) is activated and a new time zero is established, future treatment periods included in the treatment schedule are scheduled for future initiation based upon the time offsets.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and within the scope of the claims.

What is claimed is:

1. One or more computer-readable storage media having computer-executable instructions embodied thereon that, when executed, perform a method for collectively ordering multiple instances of recurring orders, the method comprising:
receiving an order, the received order having an order detail associated therewith indicating that it is to be repeated a plurality of times on a specified schedule; and
permitting each instance of the order to be independently activated the plurality of times.

2. The one or more computer-readable storage media of claim 1, wherein the specified schedule includes one or more time intervals to be applied between instances of the order.

3. The one or more computer-readable storage media of claim 1, wherein the method further comprises:
receiving a modification to the order; and
applying the modification to all instances of the order that are yet to be activated.

4. The one or more computer-readable storage media of claim 1, wherein the specified schedule includes a minimum tolerance interval to be applied between instances of the order.

5. The one or more computer-readable storage media of claim 4, wherein the method further comprises:
receiving an activation instruction for a second instance of the order;
determining that the minimum tolerance interval has not been met since activation of a first instance of the order; and
presenting an alert indicating that the minimum tolerance interval is violated.

6. The one or more computer-readable storage media of claim 1, wherein receiving an order comprises receiving a group of orders.

7. The one or more computer-readable storage media of claim 6, wherein the specified schedule includes one or more time offsets to be applied between orders in the group of orders.

8. The one or more computer-readable storage media of claim 1, wherein the method further comprises presenting each instance of the order in a single calendar-view.

9. A method for collectively ordering multiple treatment periods associated with a single treatment schedule order, the method comprising:
receiving an order indication for a treatment schedule, the treatment schedule having a plurality of identical treatment periods;
receiving an indication to activate a first of the plurality of identical treatment periods;
activating the first of the plurality of treatment periods;
receiving an indication to activate a second of the plurality of treatment periods; and
activating the second of the plurality of treatment periods, wherein a second order indication is not received prior to activating the second of the plurality of treatment periods.

10. The method of claim 9, wherein the treatment schedule includes a minimum tolerance interval to be applied between the plurality of treatment periods.

11. The method of claim 9, wherein each of the plurality of treatment periods includes at least one order detail associated therewith.

12. The method of claim 11, further comprising:
receiving a modification to the at least one order detail associated with one of the plurality of treatment periods; and
applying the modification to all of the plurality of treatment periods that are yet to be activated.

13. The method of claim 9, wherein each of the plurality of treatment periods includes a plurality of orders associated therewith, and wherein the treatment schedule includes one or more time offsets to be applied between the plurality of orders.

14. The method of claim 9, further comprising presenting each of the plurality of treatment periods in a single calendar-view.
